(19) United States
(12) Patent Application Publication
(10) Pub. No.: US 2007/0273859 A1
(43) Pub. Date: Nov. 29, 2007

(54) Illumination optical apparatus, exposure apparatus, and device manufacturing method

(76) Inventor: Hideki Komatsuda, Ageo-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/802,686

(22) Filed: May 24, 2007

(30) Foreign Application Priority Data
May 25, 2006 (JP) 2006-145179

(51) Int. Cl. G03B 27/54

(52) U.S. Cl. 355/67; 355/53

(57) ABSTRACT

An illumination optical apparatus includes a first fly-eye optical system having first optical components and a second fly-eye optical system having second optical components arranged in one-to-one correspondence to the first optical components. An illumination surface is illuminated with light from each of the second optical components in an overlapping manner. The correspondence relationship between the first optical components and the second optical components is established, so that the profile of light intensity distribution in the exit pupil of the illumination optical apparatus is almost rotationally symmetrical about an axis or substantially symmetrical about two directions perpendicular to each other, as well as almost symmetrical in shape.

### CROSS REFERENCE TO RELATED APPLICATION

This application claims the benefit of priority from Japanese Patent Application No. JP 2006-145179, filed on May 25, 2006, the entire contents of which are incorporated herein by reference.

### TECHNICAL FIELD

The present invention relates to an illumination optical apparatus, an exposure apparatus, and a device manufacturing method. More particularly, the present invention relates to an illumination optical apparatus incorporated with an exposure apparatus for manufacturing devices in a lithographic process. The manufactured devices may include semiconductor devices, image-pickup devices, liquid crystal display devices, and thin-film magnetic heads.

### BACKGROUND

In a conventional exposure apparatus for manufacturing semiconductor devices, a circuit pattern formed on a mask (reticle) is projected through a projection optical system onto a photosensitive substrate (e.g., a wafer) coated with a resist, so that the resist is exposed with exposure light through the projection optical system so as to obtain a resist pattern corresponding to the circuit pattern. The resolution of the exposure apparatus depends primarily on the wavelength of the exposure light and the numerical aperture of the projection optical system.

To improve the resolution, it is necessary to reduce the wavelength of the exposure light and/or to increase the numerical aperture of the projection optical system. In general, it is difficult to increase the numerical aperture of the projection optical system up to more than a predetermined value in an optical design. Accordingly, the wavelength of the exposure light needs to be reduced. Thus, an extreme ultraviolet lithography (EUVL) technique has been developed to become a next generation exposure method or apparatus for semiconductor patterning.

In an EUVL exposure apparatus, extreme ultraviolet (EUV) light having a wavelength of about 5 to 20 nm is employed. The wavelength of the EUV light is shorter than the wavelength (248 nm) of KrF excimer laser and the wavelength (193 nm) of ArF excimer laser, which are employed in conventional exposure apparatuses. When EUV light is employed as the exposure light, a light transmissible or refractive optical material is not available. Hence, the EUVL exposure apparatus incorporates a reflection optical integrator, a reflection mask, and a reflection projection optical system (see, for example, U.S. Pat. No. 6,452,661).

### SUMMARY

In not only the EUVL exposure apparatus but also any conventional exposure apparatus, it is preferable that the light intensity distribution formed on an exit pupil of an illumination optical apparatus (may also be referred to as a “pupil intensity distribution” below) be substantially rotationally symmetrical about an optical axis or a central axis. However, as will be described later, the illumination optical apparatus, incorporated in the EUVL exposure apparatus, is difficult to obtain the rotationally symmetrical pupil intensity distribution. If the pupil intensity distribution is not rotationally symmetrical, the line width of imaged features formed on the photosensitive substrate differs corresponding to the direction of the pattern, so that the functions of the manufactured integrated circuit tends to deteriorate.

To overcome the above problems, there is provided an illumination optical apparatus capable of illuminating a illumination surface under desired illumination conditions by forming the pupil intensity distribution substantially symmetrical about an axis, or alternatively, in two directions perpendicular to each other, by forming the pupil intensity distribution substantially symmetrical about the axes as well as with substantially the same shape. Also, there is provided an exposure apparatus capable of preferably performing exposure under preferable illumination conditions by employing the illumination optical apparatus illuminating a mask as an illumination surface under desired illumination conditions.

According to a first aspect, there is provided an illumination optical apparatus for illuminating an illumination surface with light from a light source. The illumination optical apparatus includes a first fly-eye optical system having a plurality of first optical components arranged in parallel along an optical path between the light source and the illumination surface; and a second fly-eye optical system having a plurality of second optical components arranged in parallel along an optical path between the first fly-eye optical system and the illumination surface so as to establish a one-to-one correspondence relation between the second optical components and the first optical components. The illumination surface is illuminated with light from each of the second optical components in an overlapping manner. The corresponding relationship between the first optical components and the second optical components is established so that the profile of light intensity distribution in an exit pupil of the illumination optical apparatus is substantially rotationally symmetrical about an axis or substantially symmetrical about two directions perpendicular to each other, as well as substantially symmetrical in shape.

According to a second aspect, there is provided an illumination optical apparatus for illuminating an illumination surface with light from a light source. The illumination optical apparatus includes a first fly-eye optical system having m first optical components arranged in parallel along an optical path between the light source and the illumination surface; and a second fly-eye optical system having m second optical components arranged in parallel along an optical path between the first fly-eye optical system and the illumination surface so as to establish a one-to-one correspondence relation between the m second optical components and the m first optical components. The illumination surface is illuminated with light from each of the second optical components in an overlapping manner. When the m second optical components are conceptually divided into n component groups, where n is an integer rounded down from a square root of m, so that each component group includes substantially the same number of the second optical components. A ratio of the length of the shorter side of a rectangle respectively inscribed with each component group to the length of the longer side of the rectangle is substantially ½ or more. When there are n arbitrary first optical components arranged adjacent to each other in the first fly-eye optical system, the correspondence relationship between the m first optical components and the m second optical components is established so that an evaluation value H, which is defined as follows:

$$H = {\sum }_{i = 1}^{n} ( Ri / n / Pi / A ) \times {log}_{2} ( n \times Pi \times A / Ri ) ,$$

where

$$A = {\sum }_{i = 1}^{n} Ri / n / Pi ;$$

Pi is the number of the second optical components included in the i-th (i=1 to n) component group of the second fly-eye optical system; and Ri is the number of the second optical components included in the i-th (i=1 to n) component group in the n second optical components arbitrarily corresponding to the n first optical components, is larger than the average of the maximum and the minimum values available in the evaluation value H.

According to a third aspect, there is provided an exposure apparatus for exposing a mask pattern arranged on the illumination surface onto a photosensitive substrate, which includes the illumination optical apparatus according to the first or second aspect.

According to a fourth aspect, there is provided a device manufacturing method including the steps of exposing the mask pattern onto the photosensitive substrate using the exposure apparatus according to the third aspect and developing the photosensitive substrate having the mask pattern exposed thereon.

In one of the embodiments, when the partial light is transferred from the first optical component of the first fly-eye optical system to the second optical component of the second fly-eye optical system, the partial light group reflected from the same group (the same component group) of the first fly-eye optical system is led to positions dispersed on the incident surface of the second fly-eye optical system. As a result, the profile of the pupil intensity distribution obtained according to the embodiment takes a similar shape along an arbitrary direction passing through the axis, so that the profile is to be substantially rotation symmetrical about the axis or substantially symmetrical about two directions perpendicular to each other as well as substantially symmetrical in shape.

In such a manner, in the illumination optical apparatus according to the embodiment, by forming, on an exit pupil, the light intensity distribution substantially rotation symmetrical about the axis or substantially symmetrical about two directions perpendicular to each other as well as substantially symmetrical in shape, the illumination surface can be illuminated under desired illumination conditions. Also, in the exposure apparatus according to an embodiment, by forming, on the exit pupil, the light intensity distribution substantially rotation symmetrical about the axis or substantially symmetrical about two directions perpendicular to each other as well as substantially symmetrical in shape, using the illumination optical apparatus for illuminating a mask as an illumination surface under desired illumination conditions, devices with good functions can be manufactured by performing preferable exposure under favorable conditions.

### BRIEF DESCRIPTION OF THE DRAWINGS

The accompanying drawings, which are incorporated in and constitute a part of this specification, illustrate embodiments of the invention and together with the description, serve to explain the principles of the invention.

FIG. 1 illustrates an exposure apparatus according to an embodiment.

FIG. 2 illustrates a light source, an illumination optical system, and a projection optical system shown in FIG. 1.

FIG. 3 schematically illustrates one-time scanning exposure according to the embodiment.

FIG. 4 illustrates an optical integrator according to the embodiment.

FIG. 5 illustrates a light intensity profile formed on an exit pupil of a conventional illumination optical apparatus, in which FIG. 5(a) shows the profile in x-direction and FIG. 5(b) shows the profile in y-direction.

FIG. 6 illustrates a correspondence relationship between a plurality of first concave reflection mirror components and a plurality of second concave reflection mirror components according to one embodiment in a simplified one dimensional model.

FIG. 7 illustrates a correspondence relationship between a plurality of first concave reflection mirror components and a plurality of second concave reflection mirror components according to a first modification of the embodiment, in which FIG. 7(a) shows nine adjoining first concave reflection mirror components arranged in y-direction, and FIG. 7(b) shows nine adjoining second concave reflection mirror components arranged as a three-by-three array.

FIG. 8 illustrates a correspondence relationship between a plurality of first concave reflection mirror components and a plurality of second concave reflection mirror components according to the first modification, in which FIG. 8(a) shows three adjoining first concave reflection mirror components arranged in y-direction, and FIG. 8(b) shows three adjoining second concave reflection mirror components arranged in x-direction.

FIG. 9 illustrates a plurality of the first concave reflection mirror components in a first fly-eye optical system, the first concave reflection mirror components being conceptually grouped according to a second modification of the embodiment.

FIG. 10 illustrates a plurality of the second concave reflection mirror components in a second fly-eye optical system, the second concave reflection mirror components being conceptually grouped according to the second modification of the embodiment.

FIG. 11 illustrates a first component group of the first fly-eye optical system, which includes twenty-three first concave reflection mirror components adjacent to each other according to the second modification.

FIG. 12 illustrates, in the second modification, that light passing through the i-th first concave reflection mirror component in the first component group of the first fly-eye optical system enters the second concave reflection mirror components in an i-th component group of the second fly-eye optical system.

FIG. 13 illustrates, in the second modification, that light passing through the first concave reflection mirror component in a j-th component group of the first fly-eye optical system is incident to a j-th second concave reflection mirror component in the first component group of the second fly-eye optical system.

FIG. 14 illustrates, in a second comparative example, that a plurality of the first concave reflection mirror components of the first fly-eye optical system are conceptually grouped into six groups.

FIG. 15 illustrates, in the second comparative example, that a plurality of the second concave reflection mirror components of the second fly-eye optical system are conceptually grouped into six groups.

FIG. 16 illustrates, in a third modification, that a plurality of the first concave reflection mirror components of the first fly-eye optical system are conceptually grouped.

FIG. 17 illustrates, in the third modification, that a plurality of the second concave reflection mirror components of the second fly-eye optical system are conceptually grouped.

FIG. 18 illustrates, in the third modification, that the light passing through the first concave reflection mirror component in a j-th component group of the first fly-eye optical system is incident to a j-th second concave reflection mirror component in the first component group of the second fly-eye optical system.

FIG. 19 illustrates an evaluating value H and a situation that sixteen first optical components are arbitrarily selected in the first fly-eye optical system.

FIG. 20 illustrates an example in that the positions of the second optical components, into which the light from the sixteen first optical components is incident, are distributed in the component groups.

FIG. 21 illustrates an example in that the positions of the second optical components, into which the light from the sixteen first optical components is incident, are not dispersed and are concentrated in one component group.

FIG. 22 illustrates an example in that the positions of the second optical components, into which the light from the sixteen first optical components is incident, are moderately dispersed and are concentrated in two component groups.

FIG. 23 is a flowchart illustrating a process for manufacturing a semiconductor device, such as a micro-device.

### DETAILED DESCRIPTION

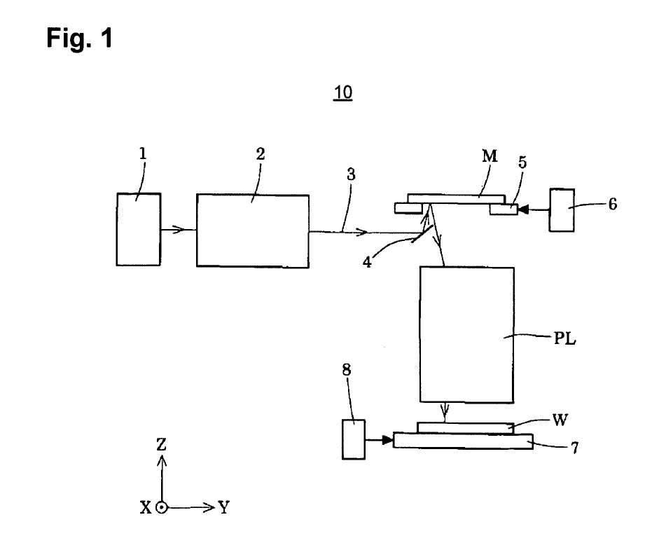

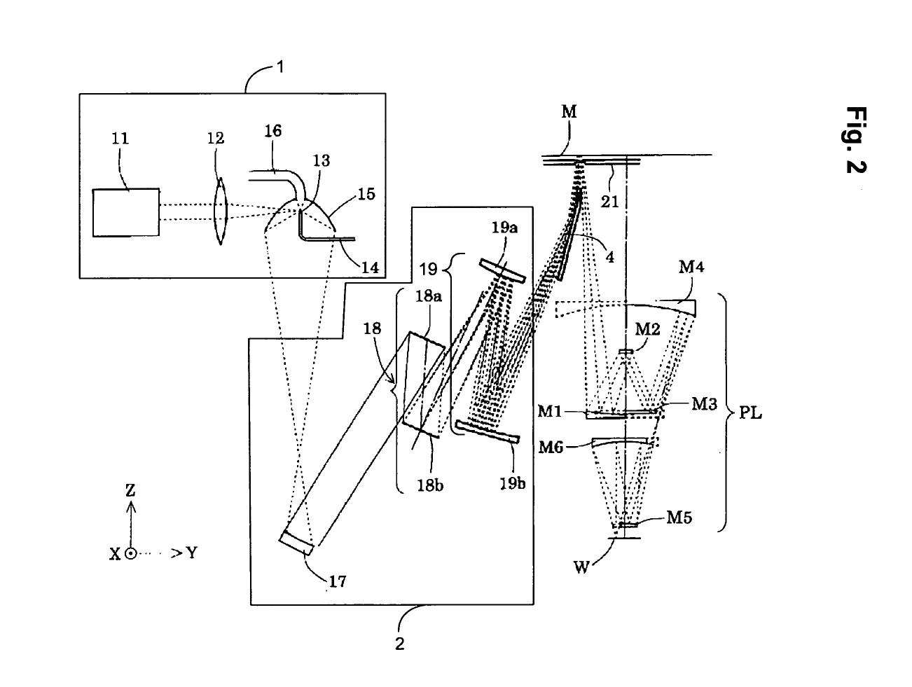

Embodiments will be described with references to the attached drawings. FIG. 1 illustrates an exposure apparatus 10 according to an embodiment. FIG. 2 illustrates a light source 1, an illumination optical system 2, and a projection optical system PL shown in FIG. 1. In FIG. 1, Z-axis may be established along an optical axial direction of projection optical system PL, i.e., a normal direction of a wafer W, which may be a photosensitive substrate; Y-axis may be established along a direction perpendicular to Z-axis and tangential to a light receiving surface of wafer W; and X-axis may be established along a direction perpendicular to Y-axis and Z-axis.

Referring to FIG. 1, exposure apparatus 10 may include a light source 1. In one embodiment, light source 1 may include a laser plasma light source for supplying exposure light. Light emitted from light source 1 enters an illumination optical system 2 via a wavelength selection filter (not shown). The wavelength selection filter may selectively transmit light with a predetermined wavelength (13.4 nm or 11.5 nm, for example) and shield light of other wavelengths. A reflection mask (reticle) M having a pattern to be transferred is irradiated by EUV light 3 passed through the wavelength selection filter, illumination optical system 2, and a plane mirror 4 which acts as a light path deflecting mirror.

Mask M may be held by a mask stage 5 movable along Y-direction so that a pattern plane of mask M may extend along XY-plane. Mask stage 5 may be configured so that its movement is measurable by a laser interferometer 6. Light from the pattern of illuminated mask M may form a mask pattern image on wafer W, which may be a photosensitive substrate, via projection optical system PL. That is, on wafer W, a circular-arc static exposure region, or an effective exposure region may be formed symmetrically about Y-axis, as will be described later.

Wafer W may be held by a wafer stage 7 two-dimensionally movable in X-direction and Y-direction so that its exposure plane extends along XY-plane. Wafer stage 7, in the same way as mask stage 5, may be configured so that its movement is measurable by a laser interferometer 8. In such a manner, while mask stage 5 and wafer stage 7 are moved along Y-direction, i.e., while mask M and wafer W are moved along Y-direction relatively to projection optical system PL, by performing scanning exposure, the pattern of mask M may be transferred onto a rectangular shot region of wafer W.

At this time, if the projection magnification (transfer magnification) is a quarter, for example, synchronous scanning may be performed by setting the moving speed of wafer stage 7 at a quarter of that of mask stage 5. Also, by repeating the scanning exposure while wafer stage 7 is two-dimensionally moved along X-direction and Y-direction, the pattern of mask M may be sequentially transferred onto each shot region of wafer W.

Referring to FIG. 2, light source 1 shown in FIG. 1 may include a laser source 11, a condenser lens 12, a nozzle 14, and a duct 16. Light (non-EUV light) emitted from laser source 11 may be condensed onto a gaseous target 13 via condenser lens 12. A high-pressure gas, such as xenon (Xe), may be supplied from nozzle 14, and the gas discharged from nozzle 14 may form gaseous target 13. Gaseous target 13 may be converted into plasma by the energy of condensed laser light so as to emit EUV light. In addition, gaseous target 13 may be positioned at a first focal point of an elliptic reflection mirror 15.

Thus, the EUV light radiated from light source 1 is condensed onto a second focal point of elliptic reflection mirror 15. On the other hand, the gas finished emission may be drained via duct 16 and led to outside. EUV light condensed onto the second focal point of elliptic reflection mirror 15 may be substantially collimated through a concave reflection mirror 17 and led to an optical integrator 18 including a pair of fly-eye optical systems 18a and 18b. The configurations and effects of first fly-eye optical system 18a and second fly-eye optical system 18b will be described later.

Thus, in the vicinity of an exit surface of optical integrator 18, i.e., in the vicinity of a reflection surface of second fly-eye optical system 18b, a substantial extended source having a predetermined shape may be formed. The substantial extended source herein is formed at the position of an exit pupil of illumination optical system 2. Light from the substantial extended source exit illumination optical system 2 via a condenser optical system 19 including a convex reflection mirror 19a and a concave reflection mirror 19b. Then, by condenser optical system 19, the above-mentioned “substantial extended source” may be projected to an exit pupil of projection optical system PL. That is, the “substantial extended source” may be conjugated with an entrance pupil of projection optical system PL.

Light from illumination optical system 2, after deflected by plane mirror 4, may form a circular-arc illumination region on mask M via a circular-arc opening (light transmission part) of a field stop 21 arranged substantially in parallel with and adjacent to mask M. In such a manner, light source 1), illumination optical system 2, plane mirror 4, and field stop 21 constitute an illumination system for Koehler-illuminating mask M having a predetermined pattern.

Light from the illuminated pattern of mask M may form a mask-pattern image on the circular-arc static exposure region via projection optical system PL. Projection optical system PL may include a first reflection imaging optical system for forming intermediate images of the pattern of mask M and a second reflection imaging optical system for forming images of the intermediate images of the mask pattern (secondary images of the pattern of mask M) on wafer W. The first reflection imaging optical system may include four reflection mirrors M1 to M4, and the second reflection imaging optical system may include two reflection mirrors M5 and M6. Projection optical system PL may be telecentric toward a wafer (on the image side).

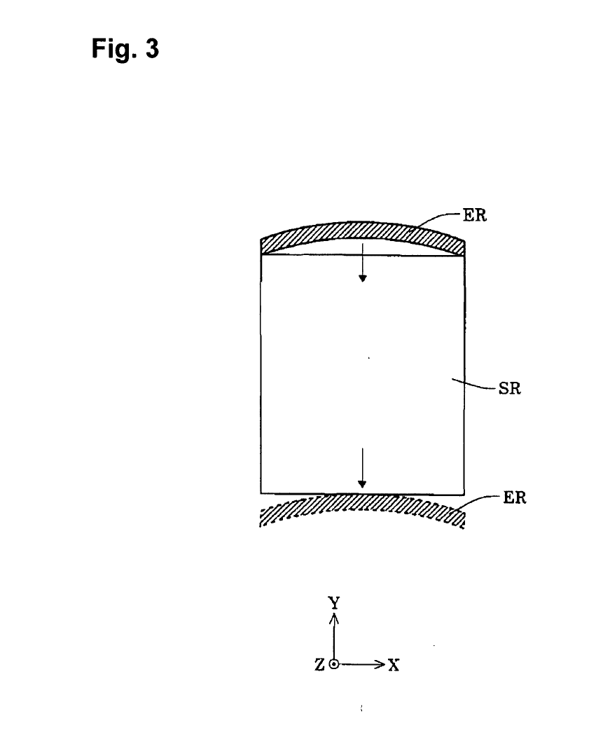

FIG. 3 schematically illustrates a one-time scanning exposure according to one embodiment. Referring to FIG. 3, a circular-arc static exposure region (an effective exposure region) ER may be formed symmetrically about Y-axis so as to correspond to a circular-arc effective imaging region and an effective field of projection optical system PL. Circular-arc static exposure region ER may move from a scanning start position, shown in solid lines in FIG. 3, to a scanning finish position, shown in broken lines in FIG. 3, when the pattern of mask M is transferred onto a rectangular one-shot region SR of wafer W by the one-time scanning exposure.

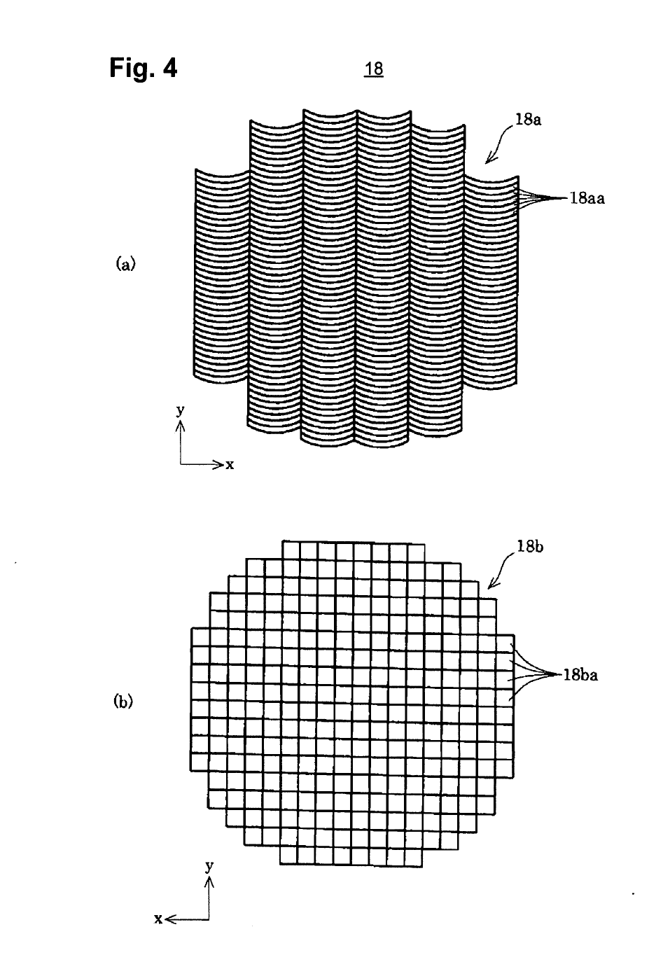

FIG. 4 illustrates an optical integrator 18 according to one embodiment. Optical integrator 18 may include a first fly-eye optical system 18a comprising a plurality of first concave reflection mirror components (first optical components) 18aa juxtaposed as shown in FIG. 4(a), and a second fly-eye optical system 18b comprising a plurality of second concave reflection mirror components (second optical components) 18ba juxtaposed in one-to-one correspondence to the first concave reflection mirror components 18aa, as shown in FIG. 4(b). Hereinafter, juxtaposition means that mirror components 18aa and 18ba are so arranged that light incident in fly-eye optical systems 18a and 18b may be divided into partial beams.

In FIG. 4(a), x-direction may be established corresponding to the X-direction on an incidence plane of fly-eye optical system 18a, and y-direction may be established corresponding to a direction perpendicular to the x-direction on the incidence plane of fly-eye optical system 18a. Similarly, in FIG. 4(b), x-direction may be established corresponding to the X-direction on a incidence plane of fly-eye optical system 18b, and y-direction may be established corresponding to a direction perpendicular to the x-direction on the incidence plane of fly-eye optical system 18b. Also, in FIG. 4, for clarity of illustration, concave reflection mirror components 18aa and 18ba of fly-eye optical systems 18a and 18b are shown to include a different number of mirrors than in a practical system. It is to be understood that the number of mirrors included in the practical system may be less or greater than, or equal to the number of mirrors illustrated.

Specifically, fly-eye optical system 18a, as shown in FIG. 4(a), is configured by compactly arranging first concave reflection mirror components 18aa, each having a circular arc external shape, lengthwise and crosswise. The reason for first concave reflection mirror component 18aa to have the circular arc external shape, as described above, is that the circular arc illumination region is formed on mask M corresponding to the circular-arc effective imaging region and the effective field of projection optical system PL. Further, circular-arc static exposure region ER is formed on wafer W corresponding to the circular arc illumination region formed on mask M.

On the other hand, fly-eye optical system 18b, as shown in FIG. 4(b), is configured by compactly arranging the second concave reflection mirror components 18ba, each having a rectangular external shape close to a square, lengthwise and crosswise. The reason for second concave reflection mirror component 18ba to have the rectangular external shape close to a square is that a substantially circular small light source is formed on the surface of second concave reflection mirror component 18ba or in the vicinity thereof.

The reason why the entrance surface of fly-eye optical system 18a is substantially circular in external shape is that the cross-sectional shape of light beam incident in optical integrator 18 (i.e., the light beam incident in first fly-eye optical system 18a) is substantially circular for improving the illumination efficiency. Also, the reason why the exit surface of fly-eye optical system 18b is substantially circular in external shape is that the external shape of light intensity distribution (the substantially extended source) formed on the exit pupil in the vicinity of the exit surface of optical integrator 18 (i.e., the exit surface of second fly-eye optical system 18b) is substantially circular.

In one embodiment, the light incident in optical integrator 18 may be wavefront-divided by first concave reflection mirror components 18aa in first fly-eye optical system 18a. The light beam reflected from each first concave reflection mirror component 18aa may enter the corresponding second concave reflection mirror component 18ba in second fly-eye optical system 18b. With the light beam reflected from each second concave reflection mirror component 18ba, the circular arc illumination region on mask M is illuminated in an overlapping manner via condenser optical system 19, which acts as a light leading optical system.

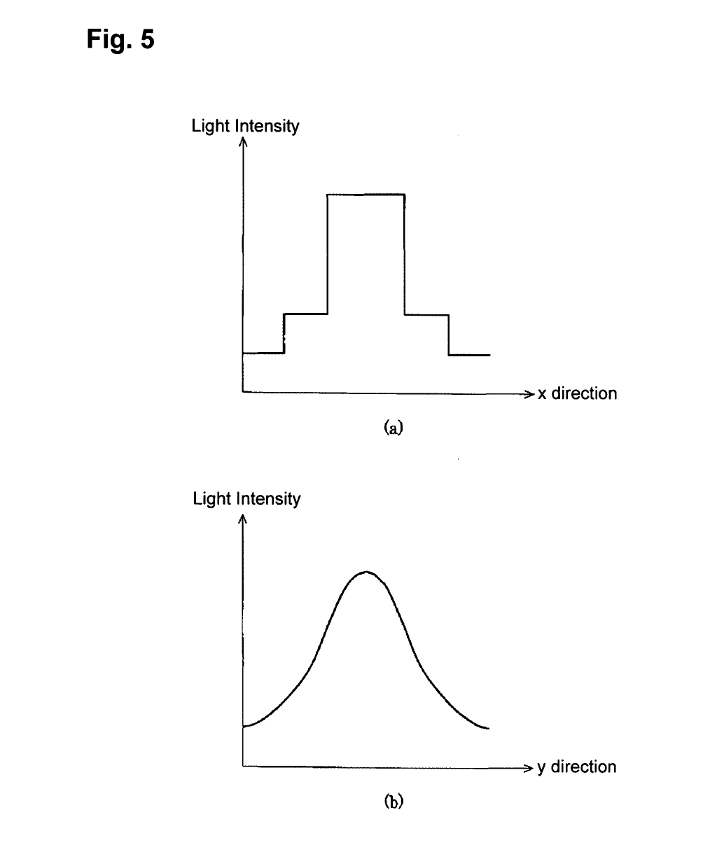

FIG. 5 illustrates a light intensity profile formed on the exit pupil of a conventional illumination optical apparatus, in which FIG. 5(a) shows the profile in x-direction and FIG. 5(b) shows the profile in y-direction. As described above, the light beam incident in optical integrator 18 is wavefront-divided by first concave reflection mirror components 18aa slenderly extending along x-direction and having circular arc external shapes. That is, as understood with reference to FIG. 4(a), the number of wavefront-divided pieces of optical integrator 18 in x-direction is considerably smaller than that in y-direction.

In a conventional technique, a correspondence relationship between first concave reflection mirror components 18aa of first fly-eye optical system 18a and second concave reflection mirror components 18ba of second fly-eye optical system 18b is not especially taken into account. Hence, when the light having a convex shaped light intensity distribution substantially symmetrical about the optical axis or the central axis (the distribution having the intensity maximum at the center decreasing toward the periphery) is incident in optical integrator 18, the profile of pupil intensity distribution obtained from the conventional technique, as shown in FIG. 5(b), is curved to continuously change in y-direction, along which the number of wavefront-divided pieces is comparatively large. Whereas, in x-direction, along which the number of wavefront-divided pieces is comparatively small, the profile, as shown in FIG. 5(a), may change discontinuously in a step-wise manner. That is, in the conventional technique, because the pupil intensity distribution is not substantially rotational symmetrical about the optical axis or the central axis, the line width of the image formed on wafer W may differ corresponding to the direction of the pattern, so that the performance of the manufactured integrated circuit are liable to deteriorate.

According to one embodiment, a number of first concave reflection mirror components 18aa may be conceptually grouped, so that first fly-eye optical system 18a may include N component groups, each group comprising N first concave reflection mirror components adjacent to each other. Similarly, a number of second concave reflection mirror components 18ba may be conceptually grouped, so that second fly-eye optical system 18b may include N component groups, each group comprising N second concave reflection mirror components adjacent to each other. Then, a correspondence relationship between a plurality of first concave reflection mirror components 18aa and a plurality of second concave reflection mirror components 18ba may be established, so that the light that has passed through the i-th component group (i=1 to N) of the first concave reflection mirror components of first fly-eye optical system 18a may enter the i-th component group (i=1 to N) of the second concave reflection mirror components of second fly-eye optical system 18b.

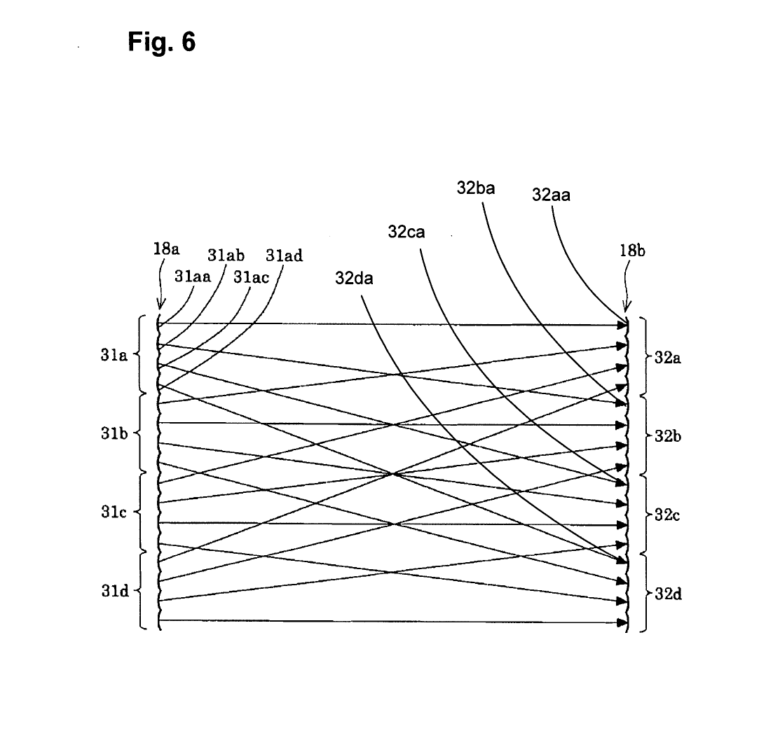

The correspondence relationship between a plurality of first concave reflection mirror components 18aa and a plurality of second concave reflection mirror components 18ba will be described below with reference to a simplified one-dimensional model, as shown in FIG. 6. In the one-dimensional model shown in FIG. 6, first fly-eye optical system 18a may include four component groups adjoined and arranged along a vertical direction of FIG. 6, each group including the first concave reflection mirror components. Also, second fly-eye optical system 18b, in the same way as in first fly-eye optical system 18a, may include four component groups adjoined and arranged along the vertical direction, each group including the second concave reflection mirror components.

When a first component group 31a of first fly-eye optical system 18a is noted, the light that has passed through a first concave reflection mirror component 31aa of first component group 31a may enter a second concave reflection mirror component 32aa of a first component group 32a of second fly-eye optical system 18b. The light that has passed through a first concave reflection mirror component 31ab of first component group 31a may enter a second concave reflection mirror component 32ba of a second component group 32b of second fly-eye optical system 18b.

The light that has passed through a first concave reflection mirror component 31ac of first component group 31a may enter a second concave reflection mirror component 32ca of a third component group 32c of second fly-eye optical system 18b. The light that has passed through a first concave reflection mirror component 31ad of first component group 31a may enter a second concave reflection mirror component 32da of a fourth component group 32d of the second fly-eye optical system 18b.

Similarly, with regard to a second component group 31b, a third component group 31c, and a fourth component group 31d, the light that have passed through first concave reflection mirror components of second component group 31b, third component group 31c, and fourth component group 31d may enter, as shown in FIG. 6, second concave reflection mirror components of first to fourth component groups 32a to 32d of second fly-eye optical system 18b, respectively. In contrast to the one-dimensional model shown in FIG. 6, optical integrator 18, in practice, may include N component groups in first fly-eye optical system 18a and N component groups in second fly-eye optical system 18b, which may be arranged in two-dimension. Further, N concave reflection mirror components of each component group may also be arranged in two-dimension.

As described above, according to one embodiment, a number of partial light formed by wavefront-dividing the beam incident in first fly-eye optical system 18a may be thoroughly rearranged and transferred to second fly-eye optical system 18b. In other words, when the partial light is transferred from first concave reflection mirror component 18aa on the entrance side of optical integrator 18 to second concave reflection mirror component 18ba on the exit side, the partial light group reflected from the same group (the same component group) of first fly-eye optical system 18a on the entrance side may not be transferred to the same group (the same component group) of second fly-eye optical system 18b on the exit side, but may be led to positions dispersed on the entrance surface of second fly-eye optical system 18b.

In such a manner, according to one embodiment, when the light having a convex shape light intensity distribution substantially symmetrical about the optical axis or the central axis enters optical integrator 18, this light having the convex shape light intensity distribution is wavefront-divided by a number of first concave reflection mirror components 18aa in first fly-eye optical system 18a. Each partial light wavefront-divided may be rearranged substantially at random, so as to arrive at each second concave reflection mirror component 18ba of second fly-eye optical system 18b. Consequently, the profile of pupil intensity distribution obtained according to one embodiment, as shown in FIG. 5(b), is curved along an arbitrary direction passing through the axis (i.e., a radial direction), so as to be rotational symmetrical about the axis.

As described above, in illumination optical apparatus 2 according to one embodiment, mask M (or wafer W by extension) can be illuminated under a desired illumination condition by forming a light intensity distribution rotationally symmetrical about the axis on the exit pupil. Also, in exposure apparatus 10 according to one embodiment, the exposure can preferably be operated by forming the light intensity distribution rotationally symmetrical about the axis on the exit pupil and using illumination optical apparatus 2 to illuminate mask M under a desired illumination condition. Specifically, on the basis of the pupil intensity distribution having a profile substantially rotationally symmetrical about the axis, a line width can be uniformised in a vertical pattern, a horizontal pattern, and a slanting direction pattern.

As described above, because the light intensity distribution being substantially symmetrical about the axis is formed on the exit pupil, the partial light group reflected from the same group (the same component group) of first fly-eye optical system 18a on the entrance side may be led to positions dispersed on the incident surface of second fly-eye optical system 18b. However, the invention is not limited thereto. A first modification may be made in that the partial light group reflected from the same group (the same component group) of first fly-eye optical system 18a on the entrance side is dispersed and led to the corresponding group (the corresponding component group).

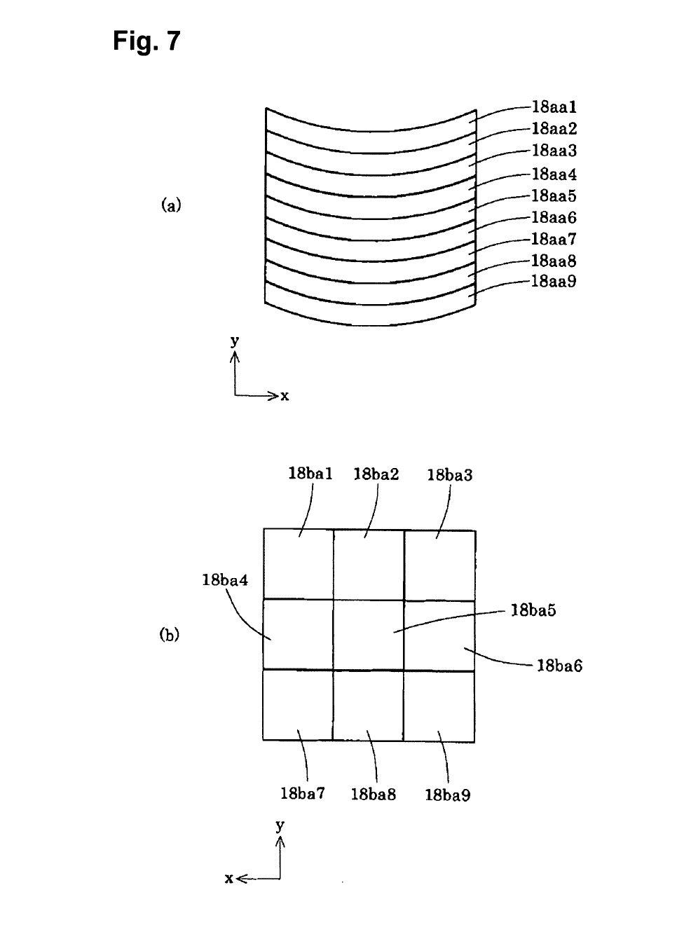

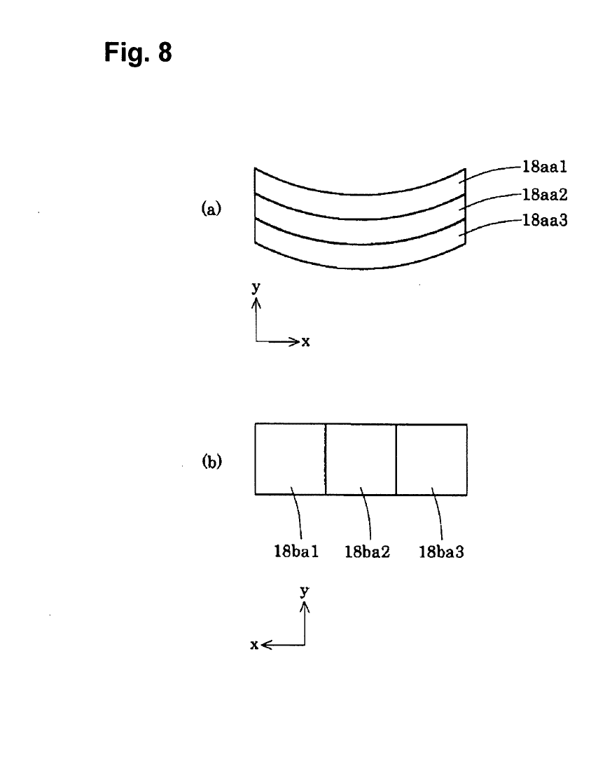

FIG. 7 illustrates a correspondence relationship between a plurality of first concave reflection mirror components and a plurality of second concave reflection mirror components according to the first modification. In FIG. 7(a), nine adjoining first concave reflection mirror components 18aa1 to 18aa9 arranged in y-direction are illustrated. In FIG. 7(b), nine adjoining second concave reflection mirror components 18ba1 to 18ba9, which are arranged lengthwise and crosswise (or arranged in a three-by-three array), are illustrated. Also, FIG. 8 illustrates a correspondence relationship between a plurality of first concave reflection mirror components and a plurality of second concave reflection mirror components according to the first modification. In FIG. 8(a), three adjoining first concave reflection mirror components 18aa1 to 18aa3 arranged in y-direction are illustrated. In FIG. 8(b), three adjoining second concave reflection mirror components 18ba1 to 18ba2 arranged in x-direction are illustrated.

According to the first modification, a number of first concave reflection mirror components 18aa may be conceptually grouped, so that first fly-eye optical system 18a may include N component groups, each group comprising r first concave reflection mirror components adjacent to each other. Similarly, a number of second concave reflection mirror components 18ba may be conceptually grouped, so that second fly-eye optical system 18b may include N component groups, each group comprising n second concave reflection mirror components adjacent to each other.

Then, a correspondence relationship between a plurality of first concave reflection mirror components 18aa and a plurality of second concave reflection mirror components 18ba may be established, so that the light that has passed through the i-th component group (i=1 to N) of the first concave reflection mirror components of first fly-eye optical system 18a may enter the i-th component group (i=1 to N) of the second concave reflection mirror components of second fly-eye optical system 18b. Furthermore, the virtual grouping of a plurality of first concave reflection mirror components 18aa and a plurality of second concave reflection mirror components 18ab may be established, so that each component group in first fly-eye optical system 18a and each component group in second fly-eye optical system 18b are inscribed with each other to have a rectangular shape or a rectangular shape close to a square.

Namely, according to the first modification, typical one component group in first fly-eye optical system 18a, as shown in FIG. 7(a), may include nine circular arc adjoining first concave reflection mirror components 18aa1 to 18aa9 arranged in y-direction, which are inscribed with each other to have a rectangular external shape close to a square. Also, the corresponding component group in second fly-eye optical system 18b, as shown in FIG. 7(b), may include 3×3=9 rectangular second concave reflection mirror components 18ba1 to 18ba9, which are inscribed with each other to have a rectangular external shape close to a square. In addition, the correspondence relationship between circular arc first concave reflection mirror components 18aa1 to 18aa9 and rectangular second concave reflection mirror component 18ba1 to 18ba9 may be appropriately varied depending on the component group.

Hence, the light wavefront-divided by one component group having a rectangular external shape close to a square in first fly-eye optical system 18a may enter one component group having a rectangular external shape close to a square in second fly-eye optical system 18b, so that the pupil intensity distributions formed on partial regions corresponding to rectangular second concave reflection mirror components 18ba1 to 18ba9 may be uniformised to some extent due to the wavefront-dividing effect. As a result, in the profile of the pupil intensity distribution previously obtained according to the first modification, as shown in FIG. 5(a), the intensity discontinuously may change step-wise in x-direction as well as in y-direction.

That is, according to the first modification, the profile of the pupil intensity distribution may not be substantially rotationally symmetrical about the axis, but may be substantially symmetrical about x-direction and y-direction as well as substantially symmetrical in shape (shaped stepwise identically to each other). In such a manner, according to the first modification, on the basis of the pupil intensity distribution having the profile substantially symmetrical about two directions perpendicular to each other (x-direction and y-direction) as well as substantially symmetrical in shape, line widths of a vertical pattern and a horizontal pattern can be uniformised.

However, according to the first modification, it may be very difficult to make the line widths of the pattern in the oblique direction uniform. In view of the equalization of the pattern line widths, one may prefer the embodiment rather than the first modification shown in FIG. 7, but it depends on a situation. However, according to the embodiment, every concave reflection mirror component must radically change the direction of the light. Thus, the concave reflection mirror components should tilt in very different directions. Thus, according to the embodiment described above, a comparatively large step is generated between two adjoining concave reflection mirror components in comparison with the first modification in some situations, so that the light amount loss may be generated in some cases.

On the other hand, according to a first comparative example, typical one component group in first fly-eye optical system 18a, as shown in FIG. 8(a), may include three circular arc adjoining first concave reflection mirror components 18aa1 to 18aa3 arranged in y-direction, which contact with each other to have a substantially rectangular external shape slenderly extending along x-direction. Also, the corresponding component group in second fly-eye optical system 18b, as shown in FIG. 8(b), may include three rectangular second concave reflection mirror components 18ba1 to 18ba3 arranged in x-direction, which contact with each other to have a rectangular external shape slenderly extending along x-direction.

In this case, the light wavefront-divided by one component group having a rectangular external shape slenderly extending along x-direction in first fly-eye optical system 18a may enter one component group having a rectangular external shape slenderly extending along x-direction in second fly-eye optical system 18b, so that the pupil intensity distributions formed on partial regions corresponding to the three rectangular second concave reflection mirror components 18ba1 to 18ba3 are uniformised to some extent due to the wavefront dividing effect.

As a result, in the profile of pupil intensity distribution obtained according to the first comparative example, as shown in FIG. 5(a), the intensity discontinuously changes step-wise in x-direction and, as shown in FIG. 5(b), is curved to continuously change in y-direction. That is, according to the first comparative example, because the shape of the pupil intensity distribution profile along x-direction is substantially different from that along y-direction, the line widths cannot be uniformised in the vertical pattern and the horizontal pattern.

As is apparent from the first modification and the first comparative example, in order to unify the line widths in the vertical pattern and the horizontal pattern by forming the pupil intensity distribution having a profile substantially symmetrical about two directions perpendicular to each other as well as substantially symmetrical in shape, the slenderness ratio of the rectangle inscribed with each component group in first fly-eye optical system 18a and each component group in second fly-eye optical system 18b is important, and the rectangular shape thus inscribed is preferably close to a square. Generally, in a rectangle (broadly understood as including a square) inscribed with each component group, if the ratio of a longer side to a shorter side is ½ or more, the line widths may be effectively uniformised to achieve a desired effect.

As described above, concave reflection mirror components may be grouped so that first fly-eye optical system 18a includes N component groups, each group including N first concave reflection mirror components, and second fly-eye optical system 18b includes N component groups, each group including N second concave reflection mirror components. However, the invention is not limited thereto. It is appreciated that a second modification may be made in that the concave reflection mirror components may be grouped so that first fly-eye optical system 18a includes N component groups, each group including n first concave reflection mirror components, and second fly-eye optical system 18b includes N component groups, each group including n second concave reflection mirror components so as to achieve a similar effect as described above.

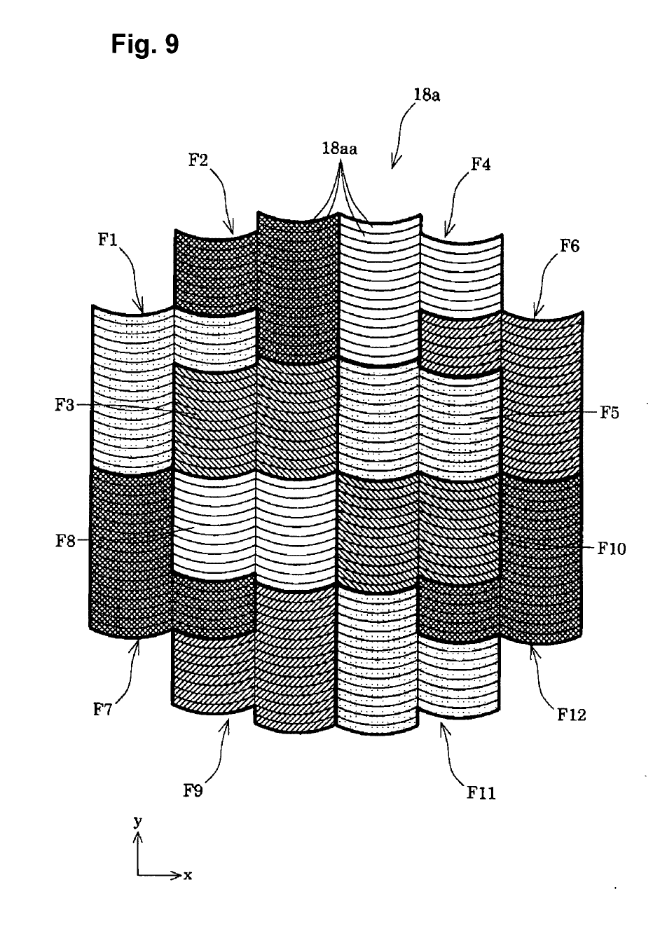

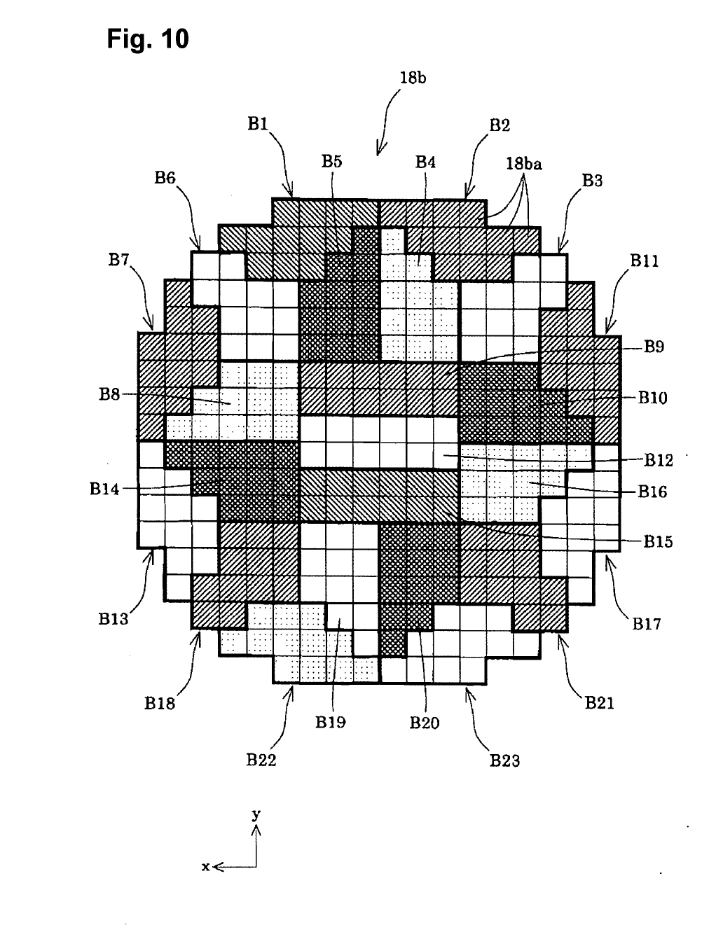

Specifically, according to the second modification, as shown in FIG. 9, 276 first concave reflection mirror components 18aa in total may be conceptually grouped so that first fly-eye optical system 18a may include twelve component groups, each group including twenty-three first concave reflection mirror components adjacent to each other. In FIG. 9, the j-th (j=1 to 12) component group is designated by reference character Fj. On the other hand, as shown in FIG. 10, 276 second concave reflection mirror components 18ba in total may be conceptually grouped so that second fly-eye optical system 18b may include twenty-three component groups, each group including twelve second concave reflection mirror components adjacent to each other. In FIG. 10, the i-th (i=1 to 23) component group is designated by reference character Bi.

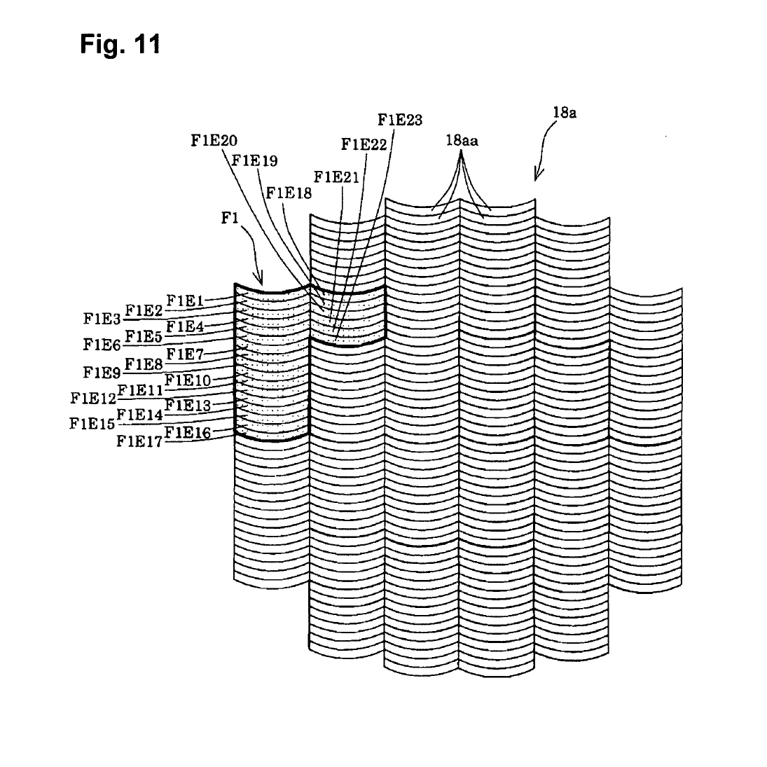

The corresponding relationship between first concave reflection mirror components 18aa and second concave reflection mirror component 18ba, according to the second modification, will be described below by noting a first component group F1 of first fly-eye optical system 18a and a first component group B1 of second fly-eye optical system 18b. First component group F1 of first fly-eye optical system 18a, as shown in FIG. 11, may include twenty-three first concave reflection mirror components adjacent to each other. In FIG. 11, the i-th (i=1 to 23) first concave reflection mirror component is designated by reference character F1Ei.

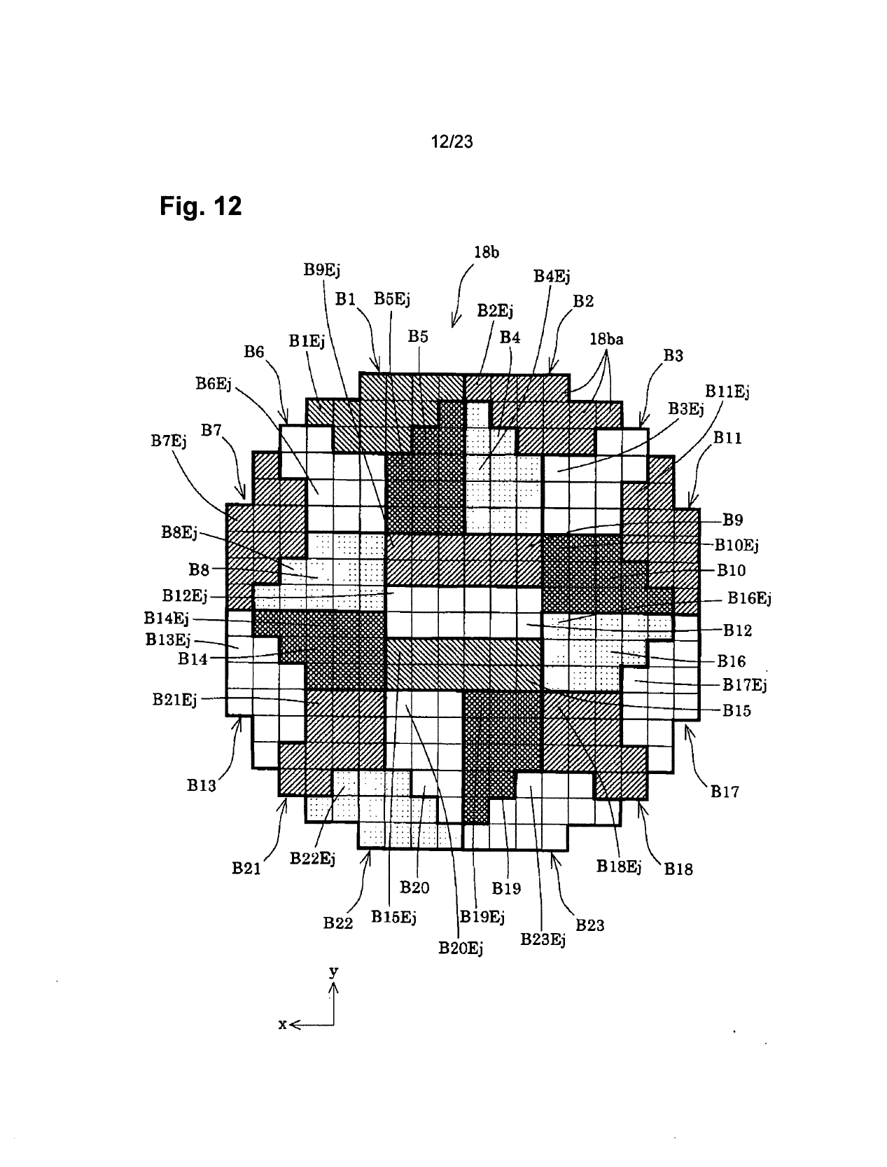

According to the second modification, with regard to first component group F1 of first fly-eye optical system 18a, the corresponding relationship between first concave reflection mirror components 18aa and second concave reflection mirror components 18ba may be established so that the light that has passed through the i-th (i=1 to 23) first concave reflection mirror component F1Ei of component group F1 may enter any second concave reflection mirror component of the i-th (i=1 to 23) component group B1 of second fly-eye optical system 18b. That is, the i-th (i=1 to 23) first concave reflection mirror component F1Ei of component group F1, as shown in FIG. 12, may correspond to any second concave reflection mirror component BiEj in the i-th (i=1 to 23) component group Bi of second fly-eye optical system 18b. Although not shown, with regard to the other component groups Fj (j=2 to 12) of first fly-eye optical system 18a, in the same way, the light that has passed through the i-th (i=1 to 23) first concave reflection mirror component FjEi of component groups Fj many enter any second concave reflection mirror component of the i-th (i=1 to 23) component group Bi of second fly-eye optical system 18b.

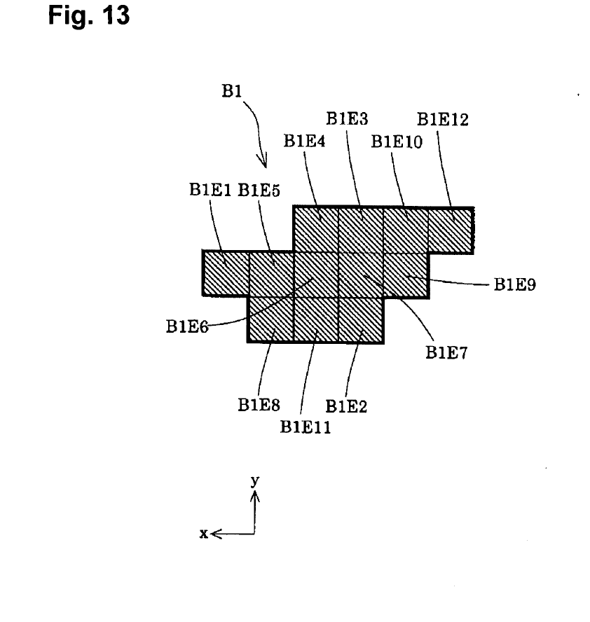

Therefore, as shown in FIG. 13, in first component group B1 of second fly-eye optical system 18b, the light that has passed through any one of first concave reflection mirror component FjEi of the j-th (j=1 to 12) component group Fj of first fly-eye optical system 18a is incident to the i-th (j=1 to 12) second concave reflection mirror component B1Ej of component group B1. Similarly, although not shown, with regard to the other component groups Bi (i=2 to 23) of second fly-eye optical system 18b, the light that has passed through any one of first concave reflection mirror component FjEi of the j-th (j=1 to 12) component group Fj of first fly-eye optical system 18a is incident to the j-th (j=1 to 12) second concave reflection mirror component BiEj of component group Bi. In such a manner, the light from all the component groups of first fly-eye optical system 18a is incident to one component group of second fly-eye optical system 18b, so that the light intensity distribution becomes substantially constant between the component groups of second fly-eye optical system 18b.

As described above, when the partial light is transferred from first concave reflection mirror component 18aa on the entrance side of optical integrator 18 to second concave reflection mirror component 18ba on the exit side, the partial light group reflected from the same component group of first fly-eye optical system 18a on the entrance side may not be transferred to the same component group of second fly-eye optical system 18b on the exit side, but may be led to positions dispersed on the incident surface of second fly-eye optical system 18b. Consequently, the profile of the pupil intensity distribution obtained according to the second modification is curved along an arbitrary direction passing through the axis (i.e., a radial direction), as shown in FIG. 5(b), so as to be substantially rotationally symmetrical about the axis in the same way as described above.

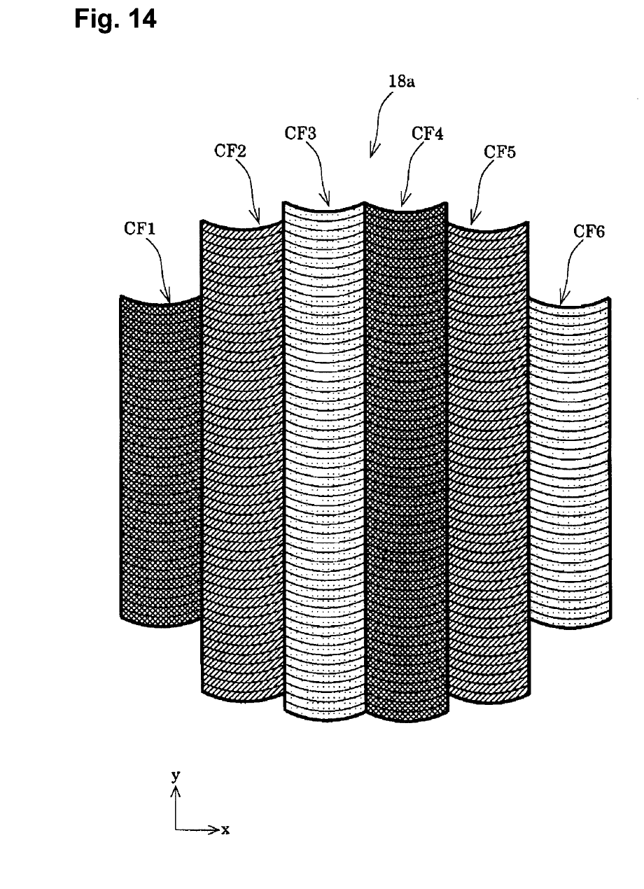

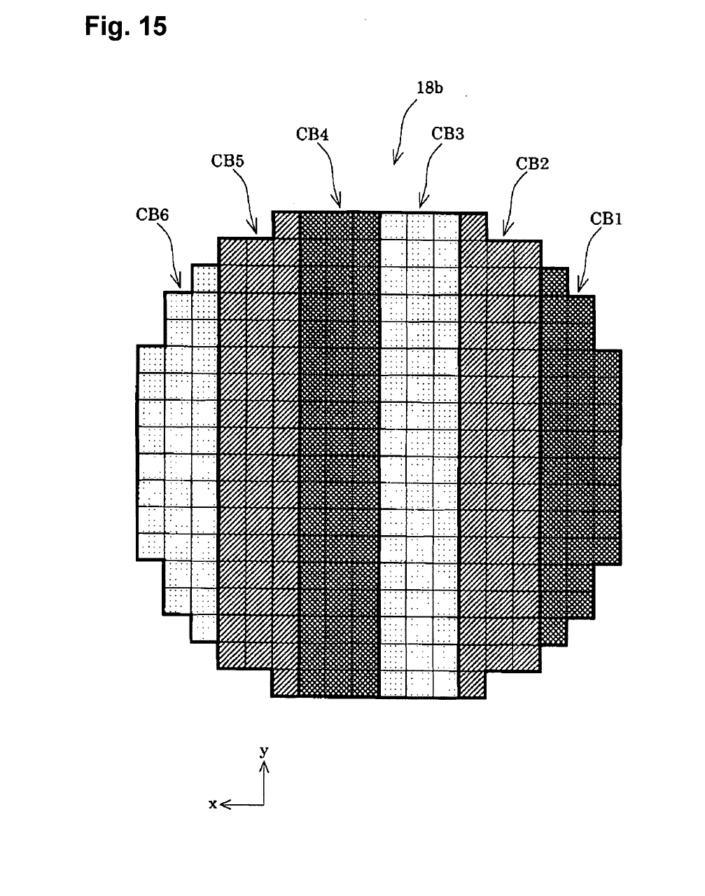

On the other hand, in a second comparative example corresponding to the second modification, a plurality of the first concave reflection mirror components in first fly-eye optical system 18a, as shown in FIG. 14, may be conceptually grouped into six component groups CF1 to CF6, each having a strip external shape slenderly extending in y-direction. Also, a plurality of the second concave reflection mirror components in second fly-eye optical system 18b, as shown in FIG. 15, may be conceptually grouped into six component groups CB1 to CB6, each having a strip external shape slenderly extending in y-direction corresponding to component groups CF1 to CF6 in first fly-eye optical system 18a.

In the second comparative example, the light wavefront-divided by a plurality of the circular arc first concave reflection mirror components slenderly extending in x-direction included in component groups CF1 to CF6 of first fly-eye optical system 18a may enter a corresponding plurality of the second concave reflection mirror components in component groups CB1 to CB6 of second fly-eye optical system 18b. Therefore, in the pupil intensity distribution obtained from the second comparative example, as shown in FIG. 5(a), the intensity discontinuously changes step-wise in x-direction, and as shown in FIG. 5(b), is curved to substantially continuously change in y-direction.

In the second modification described above, the 276 first concave reflection mirror components 18aa in total in first fly-eye optical system 18a may be conceptually grouped, and the 276 second concave reflection mirror components 18ba in total in second fly-eye optical system 18b may be conceptually grouped. However, the invention is not limited thereto. A third modification may be made in that almost all first concave reflection mirror components 18aa in first fly-eye optical system 18a are conceptually grouped, and almost all second concave reflection mirror components 18ba in second fly-eye optical system 18b are conceptually grouped so as to achieve similar effects as described above.

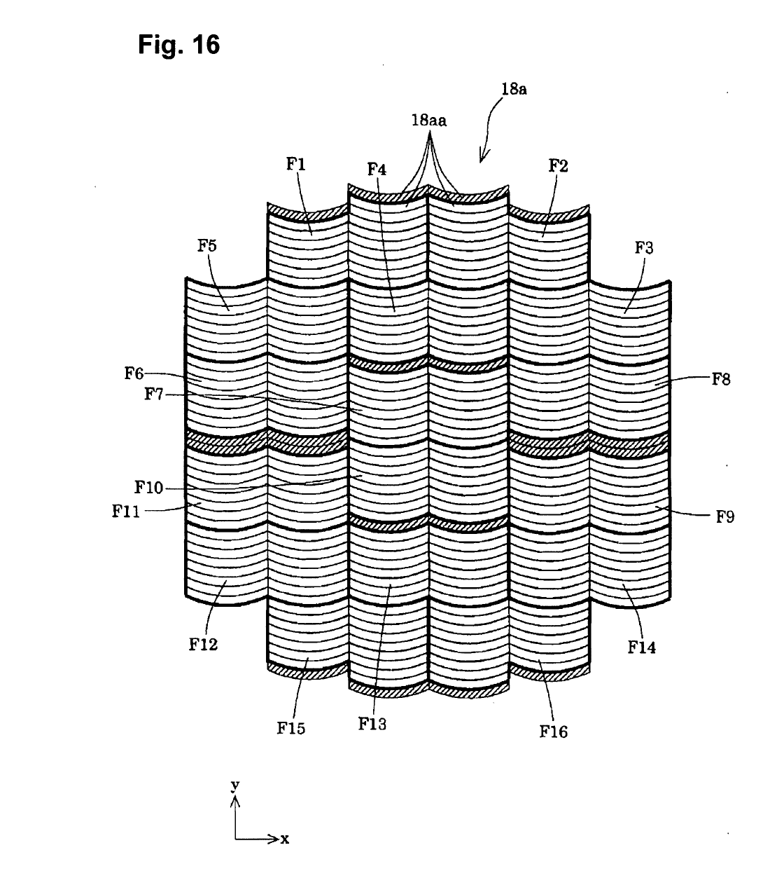

Specifically, in the third modification, as in FIG. 16, 256 first concave reflection mirror components 18aa in total may be conceptually grouped so that first fly-eye optical system 18a may include sixteen component groups, each group including sixteen first concave reflection mirror components adjacent to each other. In FIG. 16, a region surrounded by a thick line corresponds to one component group; the j-th (j=1 to 12) component group is designated by reference character Fj; and twenty first concave reflection mirror components 18aa, which do not belong to any component group, are hatched.

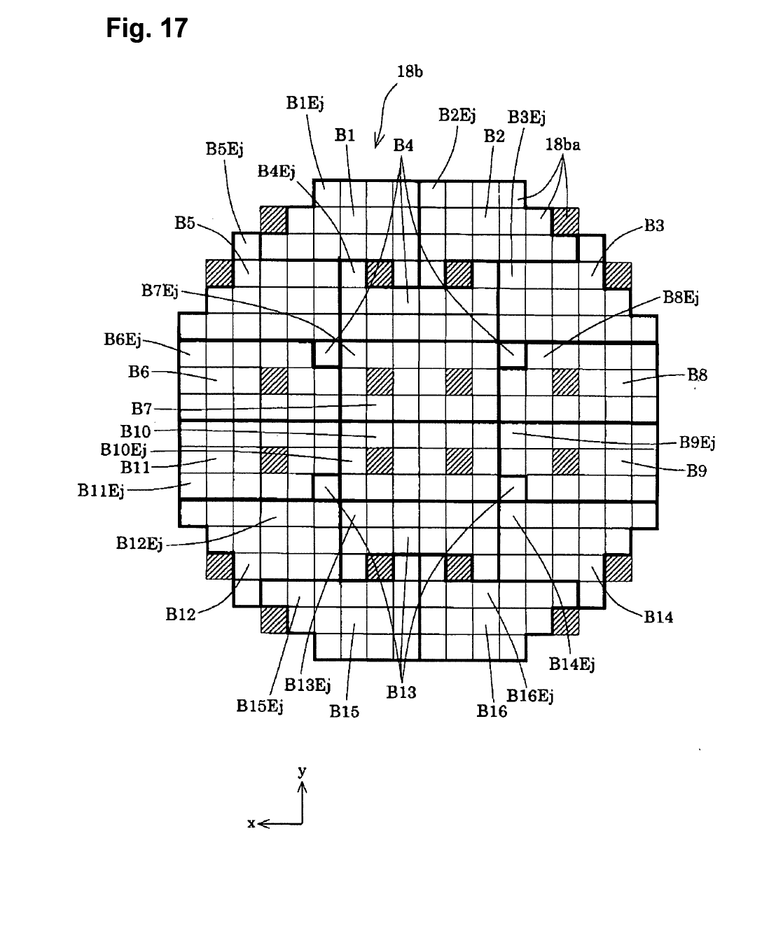

On the other hand, as shown in FIG. 17, 256 second concave reflection mirror components 18ba in total may be conceptually grouped so that second fly-eye optical system 18b may include sixteen component groups, each group including sixteen second concave reflection mirror components adjacent to each other. In FIG. 17, a region surrounded by a thick line corresponds to one component group; the i-th (i=1 to 16) component group is designated by reference character Bi; and twenty second concave reflection mirror components 18ba, which do not belong to any component group, are hatched. Component groups B4 and B13 may include second concave reflection mirror components 18ba, which are not in contact with the side of second concave reflection mirror component 18ba. In this case, all second concave reflection mirror components 18ba in component groups B4 and B13 may also be referred to as being arranged adjacent to each other.

According to the third modification, with regard to first component group F1 of first fly-eye optical system 18a, the light that has passed through the i-th (i=1 to 16) first concave reflection mirror component F1Ei of component group F1 may enter any second concave reflection mirror component of the i-th (i=1 to 16) component group B1 of second fly-eye optical system 18b. That is, the i-th (i=1 to 16) first concave reflection mirror component F1Ei of component group F1, as shown in FIG. 17, may correspond to any one of second concave reflection mirror component BiEj in the i-th (i=1 to 16) component group Bi of second fly-eye optical system 18b. Similarly, although not shown, with regard to the other component groups Fj (j=2 to 16) of first fly-eye optical system 18a, the light that has passed through the i-th (i=1 to 16) first concave reflection mirror component FjEi of component groups Fj may enter any second concave reflection mirror component of the i-th (i=1 to 16) component group Bi of second fly-eye optical system 18b.

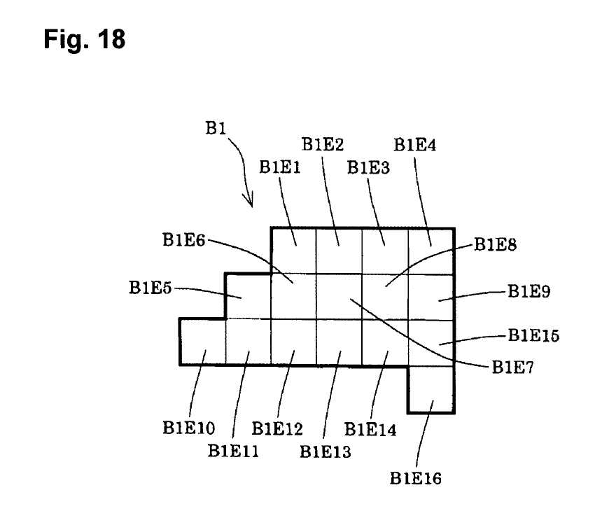

Therefore, as shown in FIG. 18, in first component group B1 of second fly-eye optical system 18b, the light that has passed through any first concave reflection mirror component FjEi of the j-th (j=1 to 16) component group Fj of first fly-eye optical system 18a is incident to the j-th (j=1 to 16) second concave reflection mirror component B1Ej of component group B1. Similarly, although not shown, with regard to the other component groups Bi (i=2 to 16) of second fly-eye optical system 18b, the light that has passed through any first concave reflection mirror component FjEi of the j-th (j=1 to 16) component group Fj of first fly-eye optical system 18a is incident to the j-th (j=1 to 16) second concave reflection mirror component BiEj of component group Bi. In such a manner, the light from all the component groups of first fly-eye optical system 18a is incident to one component group of second fly-eye optical system 18b, so that the light intensity distribution becomes substantially constant between the component groups of second fly-eye optical system 18b.

Referring to FIG. 17, twenty second concave reflection mirror components 18ba, which are not grouped, are arranged in a separated state from each other. Hence, according to the third modification, even when the correspondence relationship between twenty first concave reflection mirror components 18aa, which are not grouped, and twenty second concave reflection mirror components 18ba may be preferably established, two partial light reflected from comparatively adjacent positions in first fly-eye optical system 18a on the entrance side cannot enter comparatively adjacent positions in second fly-eye optical system 18b on the exit side.

According to the third modification, in the same way as described above, when the partial light is transferred from first concave reflection mirror component 18aa on the entrance side of optical integrator 18 to second concave reflection mirror component 18ba on the exit side, the partial light group reflected from the same component group of first fly-eye optical system 18a on the entrance side may not be transferred to the same component group of second fly-eye optical system 18b on the exit side, but may be led to positions dispersed on the incident surface of second fly-eye optical system 18b. Consequently, the profile of pupil intensity distribution obtained according to the third modification is curved along an arbitrary direction passing through the axis (i.e., a radial direction), as shown in FIG. 5(b), so as to be substantially rotationally symmetrical about the axis in the same way as described above.

In the description above, a plurality of the first concave reflection mirror components of the first fly-eye optical system are grouped into a plurality of the component groups and a plurality of the second concave reflection mirror components of the second fly-eye optical system are grouped into a plurality of the component groups, and then, a corresponding relationship is established between the first concave reflection mirror components and the second concave reflection mirror components. However, various modifications may be made for establishing the correspondence relationship between the first concave reflection mirror components and the second concave reflection mirror components so that the profile of pupil intensity distribution is substantially rotationally symmetrical about the axis and substantially symmetrical about two directions perpendicular to each other, as well as substantially symmetrical in shape.

When a correspondence relationship is established on the basis of any technique between a plurality of the first optical components (the first concave reflection mirror components) and a plurality of the second optical components (the second concave reflection mirror components), an evaluation value H will be described for evaluating the performance of this correspondence relationship that makes the profile of light intensity distribution in the exit pupil substantially rotationally symmetrical about the axis and substantially symmetrical about two directions perpendicular to each other, as well as substantially symmetrical in shape.

In principle, the number of the first optical components of the first fly-eye optical system and the number of the second optical components of the second fly-eye optical system are equal to each other. Even if it is assumed that a dummy optical component or a measurement optical component can be added to the fly-eye optical system, the number of optical components effective for contributing to the illumination should be between the number of the first optical components and the number of the second optical components. Then, the number of the first optical components (or the number of the second optical components) is designated by a number m.

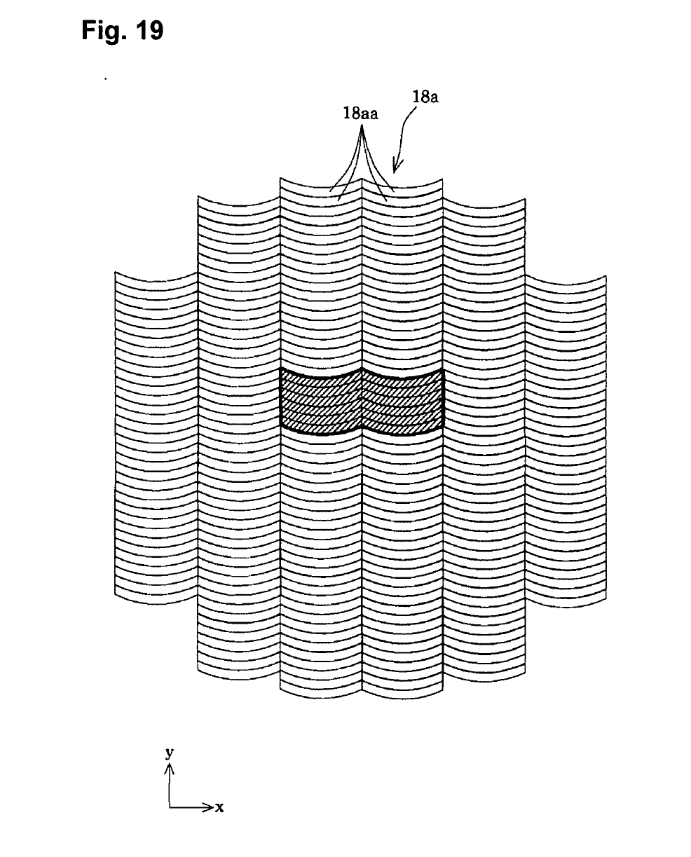

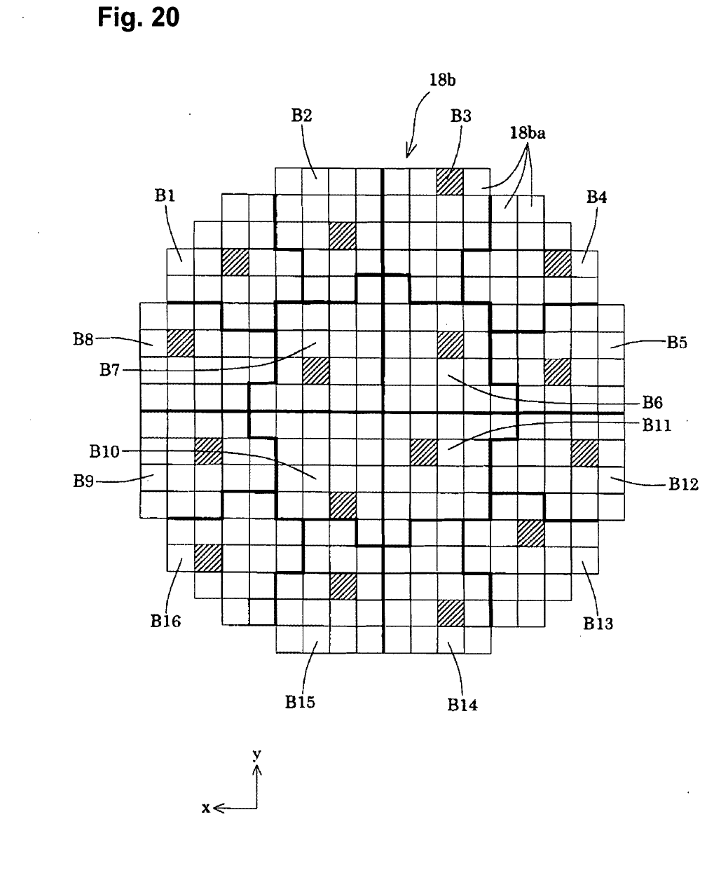

Specifically, number m of first concave reflection mirror components 18aa included in first fly-eye optical system 18a, shown in FIG. 19, is 276 and number m of second concave reflection mirror components 18ba included in second fly-eye optical system 18b, shown in FIG. 20, is also 276. Integer n herein is defined as n=Int {Sqrt (m)} (a square root of number m rounded down to an integer), and in first fly-eye optical system 18a, the r first optical components 18aa adjacent to each other may be arbitrarily assumed. For example, when number m is 276, integer n is 16. Hence, in FIG. 19, sixteen first optical components 18aa adjacent to each other may be arbitrarily selected as n first optical components 18aa adjacent to each other and hatched.

Then, the 276 second optical components 18ba (m=276) in second fly-eye optical system 18b may be conceptually divided into sixteen component groups (n=16), so that each component group includes substantially the same number of second optical components 18ba. When dividing, the components are so divided that a difference between the numbers of any two component groups of second optical components 18ba is up to one. In FIG. 20, the 276 second optical components 18ba are divided into twelve component groups, each including seventeen second optical components 18ba, and four component groups, each including eighteen second optical components 18ba.

Specifically, in sixteen component groups B1 to B16 divided with solid lines in FIG. 20, the component groups having seventeen second optical components 18ba are groups B1 to B5, B8, B9, and B12 to B16; and the component groups having second optical components 18ba are groups B6, B7, B10, and B11. When dividing, the components are divided so that each component group has a minimum circumferential length, i.e., the external shape of each component group is not elongated. Specifically, the length difference between the longer side and the shorter side of a rectangle respectively inscribed with each component group is reduced to as small as possible. For example, the ratio of the length of the shorter side of a rectangle respectively inscribed with each component group to that of the longer side is to be ½ or more.

Then, suppose that the light reflected from the sixteen first optical components 18aa selected in FIG. 19 is incident into certain numbers of second optical components 18ba in component groups B1 to B16 of second fly-eye optical system 18b. The evaluation value H mentioned above is defined as the following equation (1):

$$H = {\sum }_{i = 1}^{n} ( Ri / n / Pi / A ) \times {log}_{2} ( n \times Pi \times A / Ri ) , \qquad ( 1 )$$

where

$$A = {\sum }_{i = 1}^{n} Ri / n / Pi ;$$

Pi is the number of the second optical components included in the i-th (i=1 to 16) component group of second fly-eye optical system 18b; and Ri is the number of the second optical components included in the i-th (i=1 to n) component group in the sixteen second optical components arbitrarily corresponding to the sixteen first optical components.

In equation (1), the value of evaluation value H is zero when Ri=0. Evaluation value H is the so-called “entropy” and an index of the position dispersibility of second optical components 18ba is larger than the average of the maximum and the minimum values available in evaluation value H. When evaluating value H herein, which changes according to the position dispersibility of second optical components 18ba in which the light arbitrarily reflected from the sixteen first optical components 18aa is incident, the profile of the light intensity distribution in the exit pupil of the illumination optical apparatus is evaluated to be substantially rotation symmetrical about the axis or substantially symmetrical about two directions perpendicular to each other, as well as substantially symmetrical in shape.

For example, when second optical components 18ba (hatched optical components in FIG. 20), in which the light reflected from the sixteen selected first optical components 18aa is incident, as shown in FIG. 20, are distributed every one component among the component groups B1 to B16, evaluation value H becomes the maximum as expressed by the following equation (1a):
H=1/16/17/0.05801×log₂(16×17×0.05801)×12+1/16/18/0.05801×log₂(16×18×0.05801)×4≈1.790 (1a),
where A=(1/16/17)×12+(1/16/18)×4≈5.801×10⁻²=0.05801.

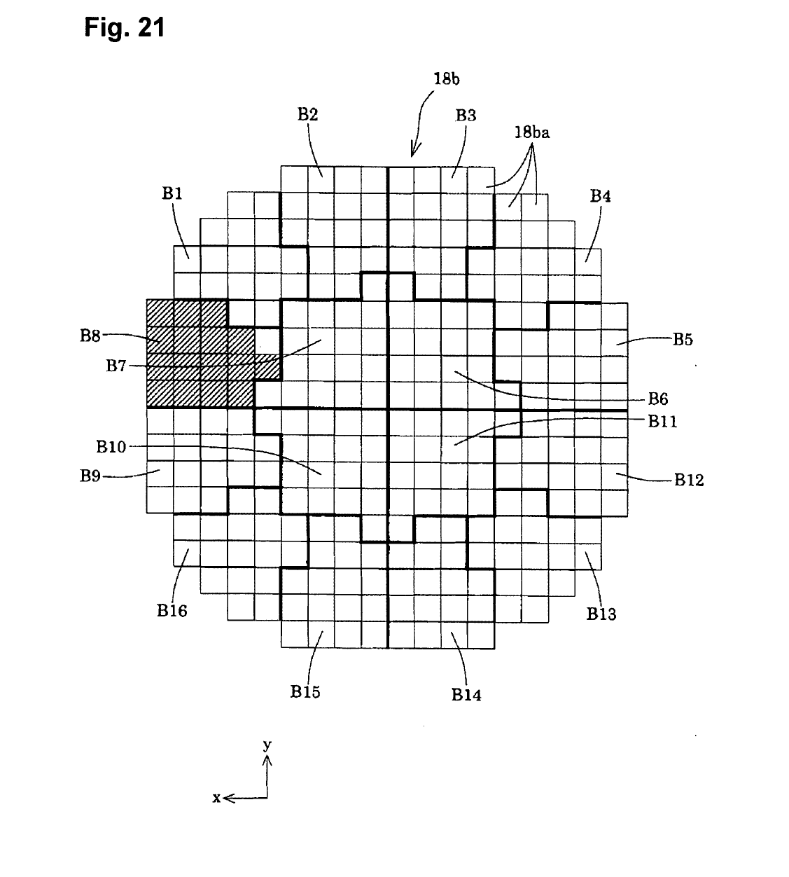

On the other hand, when second optical components 18ba, in which the light reflected from the sixteen selected first optical components 18aa is incident, as shown by hatching in FIG. 21, are not well distributed to concentrate onto one component group B8, evaluation value H becomes the minimum as expressed by the following equation (1b):
H=16/16/17/0.05882×log₂(16×17×0.05882/16)≈0 (1b),
where A=(16/16/17)≈5.882×10⁻²=0.05882.

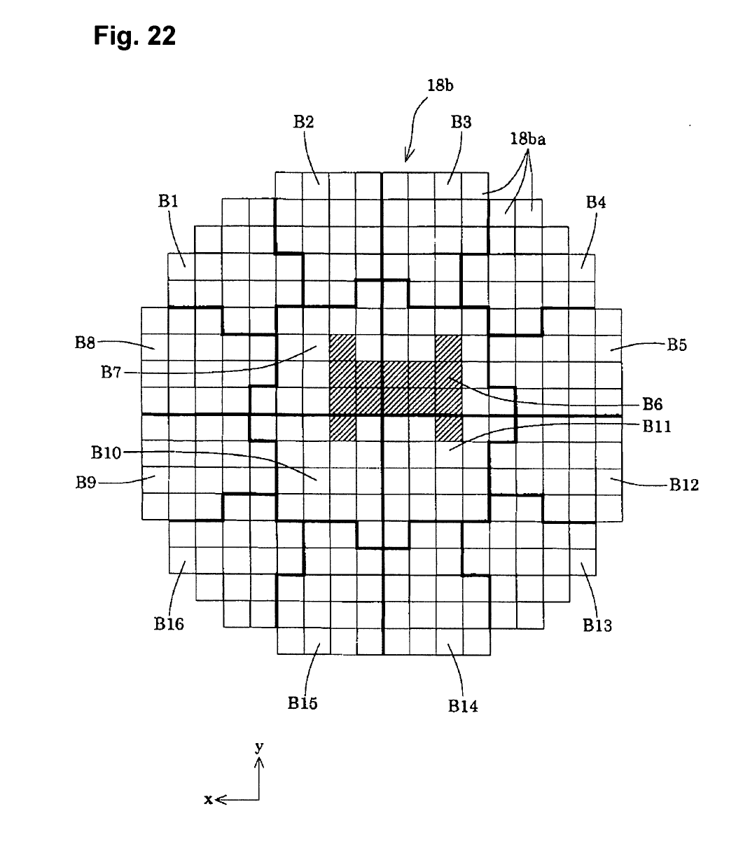

In this example, second optical components 18ba, in which the light reflected from the sixteen selected first optical components 18aa is incident, as shown by hatching in FIG. 22, are rather not well distributed to almost concentrate into component groups B6 and B7. Consequently, evaluation value H, as expressed in the following equation (1c), is less than the average 0.8948 of the maximum value 1.790 and the minimum value 0:
H=7/16/18/0.05556×log₂(16×17×0.05556/7)×2+1/16/18/0.05556×log₂(16×18×0.05556)×2≈0.4647<0.8948 (1c),
where A=(7/16/18)×2+(1/16/18)×2≈5.556×10⁻²=0.05556.

As described above, it is preferable that in each component group of at least one of first fly-eye optical system 18a and second fly-eye optical system 18b, a plurality of the concave reflection mirror components (optical components) have focal distances different from each other. In particular, for light beams from a plurality of second concave reflection mirror components 18ba of second fly-eye optical system 18b, a circular-arc illumination region on mask M may be illuminated via condenser optical system 19 in an overlapping manner. The light beams may not be completely superposed thereon and may be slightly displaced from each other due to the aberration of a light leading optical system. In such a case, the displacement of the light beams may be alleviated by making focal distances of a plurality of second concave reflection mirror components 18ba different from each other.

As described above, each of the first concave reflection mirror components has a circular-arc external shape while each of the second concave reflection mirror components has a strip rectangular external shape. However, the invention is not limited thereto. It is appreciated that each optical component may have various external shapes, such as a rectangle, a circle, and/or an ellipse. According to one embodiment, the shape of first concave reflection mirror component 18aa of first fly-eye optical system 18a may be a circular arc identical or not identical to that of the illumination region on the mask face. For example, the external shape of first concave reflection mirror component 18aa may be a rectangle while that of the illumination region on the mask face may be a circular arc. Also, as described above, the present invention is applicable to all the optical components. However, the invention is not limited thereto. It is appreciated that optical components in only one specific required region may be incorporated in the invention.

As described above, the present invention is applicable to the illumination optical apparatus having a reflection optical integrator. However, the invention is not limited thereto. It is appreciated that the illumination optical apparatus having a refraction optical integrator may be incorporated in the invention, for example. In this case, the first fly-eye optical system and the second fly-eye optical system are configured by arranging optical components such as micro-lens components in parallel.

As described above, the present invention is applicable to the illumination optical apparatus of the EUVL exposure apparatus including the reflection mask M. However, the invention is not limited thereto. It is appreciated that a general illumination apparatus for illuminating an illumination surface with light from a light source may also be incorporated in the invention.

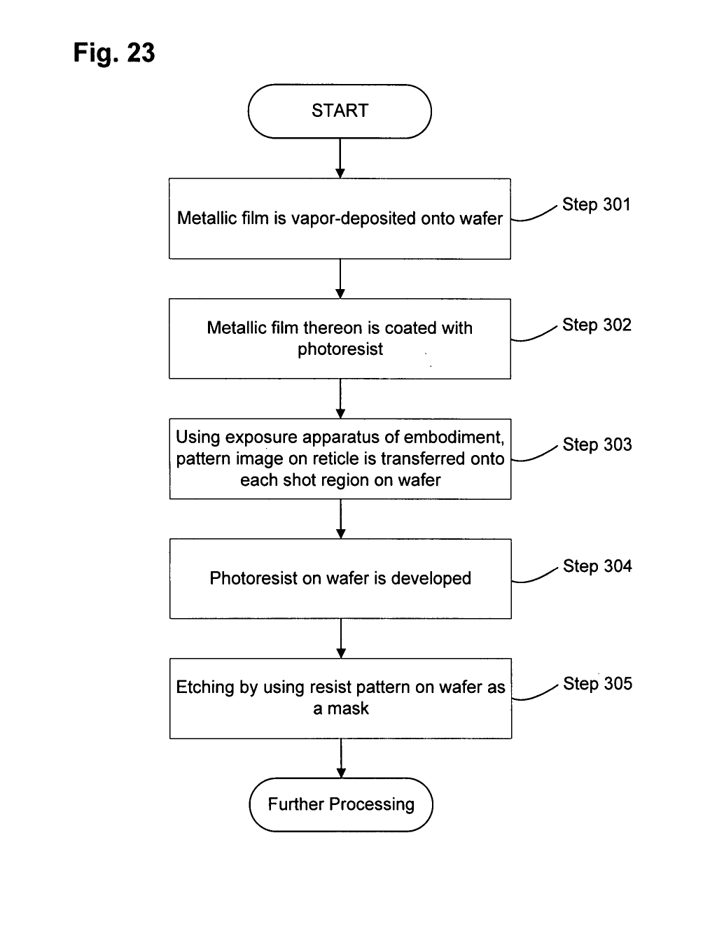

In the exposure apparatus according to one embodiment, micro-devices (semiconductor devices, image-pickup devices, liquid crystal display devices, and thin-film magnetic heads) can be manufactured by illuminating a mask with an illumination system (an illumination process) and by exposing a pattern to be transferred and formed on the mask onto a photosensitive substrate using a projection optical system (an exposure process). A process for obtaining semiconductor devices, such as the micro-devices, by forming a predetermined circuit pattern on a wafer as the photosensitive substrate using the exposure apparatus according to one embodiment will be described below with reference to the flowchart shown in FIG. 23.

First, in step 301 shown in FIG. 23, metallic films are vapor-deposited onto a plurality of wafers in one lot. Next, in step 302, the metallic films on the wafers are coated with a photoresist. Then, in step 303, by using the exposure apparatus described above, a pattern image on a mask (a reticle) is sequentially exposed and transferred onto each shot region of the wafers via a projection optical system.

Thereafter, in step 304, the photoresist on the wafers is developed. Then, in step 305, a circuit pattern corresponding to the pattern on the mask is formed on each shot region on each wafer by etching the resist patterns on the wafers as masks. Then, by forming a circuit pattern on an upper layer, devices such as semiconductor devices are manufactured for further processing. According to the process for manufacturing semiconductor devices, semiconductor devices having an extremely fine circuit pattern can be obtained with a high throughput.

In the EUVL exposure apparatus described above, a laser plasma light source is used for a light source for supplying EUV light. However, the invention is not limited thereto. It is appreciated that other appropriate light sources for supplying the EUV light, such as a synchrotron radiation (SOR) light source, may also be used.

As described above, each reflection mirror component of the first fly-eye optical system and the second fly-eye optical system may have either a concave shape or various other shapes, such as convex, planar, and non-spherical shapes. The shapes of all the reflection mirror components of the first fly-eye optical system are not necessarily the same. Furthermore, an actuator may be arranged for adjusting the position and the angle of each reflection mirror component. By doing so, the correspondence relationship between reflection mirror components 18aa of first fly-eye optical system 18a and reflection mirror components 18ba of second fly-eye optical system 18b may be arbitrarily changed. For example, when the illumination conditions are changed, the illumination intensity distribution can be adjusted.

As described above, on the exit pupil of the illumination optical system, the illumination intensity distribution about rotation symmetrical about the axis is formed. Furthermore, when it is preferable that the entire intensity distributions be substantially constant in broad perspective, the correspondence relationship between reflection mirror components 18aa and reflection mirror components 18ba may be established so as to be almost constant in broad perspective.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An illumination optical apparatus for illuminating an illumination surface with light from a light source, the apparatus comprising:
a first fly-eye optical system having a plurality of first optical components arranged in parallel along an optical path between the light source and the illumination surface; and
a second fly-eye optical system having a plurality of second optical components arranged in parallel along an optical path between the first fly-eye optical system and the illumination surface, the second optical components being in a one-to-one correspondence relationship with the first optical components;
wherein the illumination surface is illuminated with light from each of the second optical components in an overlapping manner, and
wherein the one-to-one correspondence relationship is established so that an intensity distribution profile of light in an exit pupil of the illumination optical apparatus is substantially rotationally symmetrical about an axis or substantially symmetrical about two perpendicular directions, and substantially symmetrical in shape.

2. The apparatus according to claim 1, wherein the first fly-eye optical system includes N component groups, each group including N first optical components, and the second fly-eye optical system includes N component groups, each group including N second optical components, and
wherein the one-to-one correspondence relationship is established so that light passing through the i-th (i=1 to N) first optical component in each component group of the first fly-eye optical system enters the second optical components in the i-th (i=1 to N) component group of the second fly-eye optical system.

3. The apparatus according to claim 1, wherein the first fly-eye optical system includes N component groups, each group including n first optical components and the second fly-eye optical system includes N component groups, each group including n second optical components,
wherein the correspondence relationship is established so that light passing through each first optical component in the i-th (i=1 to N) component group of the first fly-eye optical system enters the second optical components in the i-th (i=1 to N) component group of the second fly-eye optical system, and
wherein each component group of the first fly-eye optical system and the second fly-eye optical system is inscribed with a rectangle shape having a longer side and a shorter side, a ratio between lengths of the shorter side and the longer side being substantially ½ or more.

4. The apparatus according to claim 1, wherein the first fly-eye optical system includes N component groups, each group including n first optical components and the second fly-eye optical system includes n component groups, each group including N second optical components, and
wherein the correspondence relationship is established so that light passing through the i-th (i=1 to n) first optical component in at least one component group of the first fly-eye optical system enters the second optical components in the i-th (i=1 to n) component group of the second fly-eye optical system.

5. The apparatus according to claim 4, wherein the light passing through the i-th (i=1 to n) first optical component in all the component groups of the first fly-eye optical system enters the second optical components in the i-th (i=1 to n) component group of the second fly-eye optical system.

6. The apparatus according to claim 1, wherein in each component group of at least one of the first fly-eye optical system and the second fly-eye optical system, at least two of the optical components in each component group have focal distances different from each other.

7. The apparatus according to claim 1, wherein the first optical components and the second optical components comprise concave reflection mirrors, respectively.

8. The apparatus according to claim 1, wherein each of the first optical components has a circular-arc external shape, while each of the second optical components has a rectangular external shape.

9. The apparatus according to claim 1, wherein the first optical components included in one component group of the first fly-eye optical system are arranged adjacent to each other.

10. The apparatus according to claim 1, wherein the second optical components included in one component group of the second fly-eye optical system are arranged adjacent to each other.

11. An illumination optical apparatus for illuminating an illumination surface with light from a light source, the apparatus comprising:
a first fly-eye optical system having m first optical components arranged in parallel along an optical path between the light source and the illumination surface; and
a second fly-eye optical system having m second optical components arranged in parallel along an optical path between the first fly-eye optical system and the illumination surface, the m second optical components having a one-to-one correspondence relationship with the m first optical components;
wherein the illumination surface is illuminated with light from each of the second optical components in an overlapping manner,
wherein when the m second optical components are conceptually divided into n component groups, where n is an integer rounded down from a square root of m, so that each component group includes substantially the same number of the second optical components,
wherein each component group is inscribed with a rectangle shape having a longer side and a short side, a ratio between lengths of the shorter side and the longer side being substantially ½ or more, and
wherein when there are n arbitrary second optical components adjacent to each other in the first fly-eye optical system, the correspondence relationship is established so that an evaluation value H is larger than an average of a maximum value and a minimum value of available evaluation values H, the evaluation value H being defined as:
$$H = {\sum }_{i = 1}^{n} ( Ri / n / Pi / A ) \times {log}_{2} ( n \times Pi \times A / Ri ) ,$$
where
$$A = {\sum }_{i = 1}^{n} Ri / n / Pi ;$$
Pi is the number of the second i=1 optical components included in the i-th (i=1 to n) component group of the second fly-eye optical system; and Ri is the number of the second optical components included in the i-th (i=1 to n) component group in the n second optical components arbitrarily corresponding to the n first optical components.

12. The apparatus according to claim 11, wherein the m first optical components and the m second optical components comprise concave reflection mirrors, respectively.

13. The apparatus according to claim 12, wherein each of the m first optical components has a circular-arc external shape, while each of the m second optical components has a rectangular external shape.

14. The apparatus according to claim 11, wherein the m first optical components in the first fly-eye optical system are arranged adjacent to each other.

15. The apparatus according to claim 11, wherein the m second optical components in the second fly-eye optical system are arranged adjacent to each other.

16. An illumination optical apparatus for illuminating an illumination surface with light from a light source, the apparatus comprising:
a first fly-eye optical system having a plurality of first optical components arranged in parallel along an optical path between the light source and the illumination surface; and
a second fly-eye optical system having a plurality of second optical components arranged in parallel along an optical path between the first fly-eye optical system and the illumination surface, the second optical components having a one-to-one correspondence relationship with the first optical components;
wherein the illumination surface is illuminated with light from each of the second optical components in an overlapping manner,
wherein the first fly-eye optical system includes N component groups, each group including the N first optical components and the second fly-eye optical system includes N component groups, each group including the N second optical components, and
wherein the correspondence relationship is established so that light passing through the i-th (i=1 to N) first optical component in each component group of the first fly-eye optical system enters the second optical components in the i-th (i=1 to N) component group of the second fly-eye optical system.

17. An illumination optical apparatus for illuminating an illumination surface with light from a light source, the illumination optical apparatus comprising:
a first fly-eye optical system having a plurality of first optical components arranged in parallel along an optical path between the light source and the illumination surface; and
a second fly-eye optical system having a plurality of second optical components arranged in parallel along an optical path between the first fly-eye optical system and the illumination surface, the second optical components having a one-to-one correspondence relationship with the first optical components,
wherein the illumination surface is illuminated with light from each of the second optical components in an overlapping manner,
wherein the first fly-eye optical system includes N component groups, each group including the n first optical components, and the second fly-eye optical system includes N component groups, each group including the n second optical components,
wherein the correspondence relationship is established so that light passing through each first optical component in the i-th (i=1 to N) component group of the first fly-eye optical system enters each second optical component in the i-th (i=1 to N) component group of the second fly-eye optical system, and
wherein each component group of the first fly-eye optical system and each component group of the second fly-eye optical system are inscribed with a rectangle shape having a longer side and a shorter side, a ratio of lengths of the shorter side and the longer side being substantially ½ or more.

18. An illumination optical apparatus for illuminating an illumination surface with light from a light source, the apparatus comprising:
a first fly-eye optical system having a plurality of first optical components arranged in parallel along an optical path between the light source and the illumination surface; and
a second fly-eye optical system having a plurality of second optical components arranged in parallel along an optical path between the first fly-eye optical system and the illumination surface, the second optical components having a one-to-one correspondence relationship with the first optical components,
wherein the illumination surface is illuminated with light from each of the second optical components in an overlapping manner,
wherein the first fly-eye optical system includes N component groups, each group including n first optical components, and the second fly-eye optical system includes n component groups, each group including N second optical components, and
wherein the correspondence relationship is established so that light passing through the i-th (i=1 to n) first optical component in at least one component group of the first fly-eye optical system enters the second optical components in the i-th (i=1 to n) component group of the second fly-eye optical system.

19. The apparatus according to claim 18, wherein the light that has passed through the i-th (i=1 to n) first optical component in all the component groups of the first fly-eye optical system enters the second optical components in the i-th (i=1 to n) component group of the second fly-eye optical system.

20. The apparatus according to claim 16, wherein, in each component group of at least one of the first fly-eye optical system and the second fly-eye optical system, at least two of the optical components in each component group have focal distances different from each other.

21. The apparatus according to claim 16, wherein each of the first optical components and each of the second optical components comprise concave reflection mirrors, respectively.

22. The apparatus according to claim 16, wherein each of the first optical components has a circular-arc external shape, while each of the second optical components has a rectangular external shape.

23. The apparatus according to claim 16, wherein the first optical components included in one component group of the first fly-eye optical system are arranged adjacent to each other.

24. The apparatus according to claim 16, wherein the second optical components included in one component group of the second fly-eye optical system are arranged adjacent to each other.

25. An exposure apparatus for exposing a mask pattern arranged on the illumination surface onto a photosensitive substrate, the exposure apparatus comprising the illumination optical apparatus according to claim 1.

26. A device manufacturing method, comprising:
exposing the mask pattern onto the photosensitive substrate using the exposure apparatus according to claim 25; and
developing the photosensitive substrate having the mask pattern exposed thereon.

27. The apparatus according to claim 17, wherein, in each component group of at least one of the first fly-eye optical system and the second fly-eye optical system, at least two of the optical components in each component group have focal distances different from each other.

28. The apparatus according to claim 18, wherein, in each component group of at least one of the first fly-eye optical system and the second fly-eye optical system, at least two of the optical components in each component group have focal distances different from each other.

29. The apparatus according to claim 19, wherein, in each component group of at least one of the first fly-eye optical system and the second fly-eye optical system, at least two of the optical components in each component group have focal distances different from each other.
